(19) United States
(12) Patent Application Publication
(10) Pub. No.: US 2025/0133195 A1
(43) Pub. Date: Apr. 24, 2025

(54) IMAGE PROCESSING DEVICE AND METHOD

(71) Applicant: Sony Group Corporation, Tokyo (JP)

(72) Inventors: Kazuki YOKOYAMA, Kanagawa (JP); Ruri OYA, Kanagawa (JP); Tomoya YANO, Kanagawa (JP); Yuta YOSHIMIZU, Kanagawa (JP); Noriyuki KATO, Kanagawa (JP); Kohki WATANABE, Tokyo (JP)

(73) Assignee: Sony Group Corporation, Tokyo (JP)

(21) Appl. No.: 18/834,228

(22) PCT Filed: Feb. 15, 2023
(86) PCT No.: PCT/JP2023/005103

§ 371 Date: Jul. 30, 2024

(30) Foreign Application Priority Data
Feb. 28, 2022 (JP) 2022-029542

(51) Int. Cl. H04N 13/144; G06T 3/40; G06T 7/593; H04N 13/128; H04N 13/275; H04N 13/363; H04N 13/366; H04N 13/398

(52) U.S. Cl. CPC H04N 13/144; G06T 3/40; G06T 7/593; H04N 13/128; H04N 13/275; H04N 13/363; H04N 13/366; H04N 13/398; G06T 2207/10012; H04N 2213/002

(57) ABSTRACT

There is provided an image processing device and method that can suppress degradation in the stereoscopic effect and visibility of a stereoscopic image and suppress an accommodative-convergence conflict. Scaling transformation is performed on a stereoscopic object according to the angle of a display surface with respect to a horizontal plane of a real space, a stereoscopic image to be displayed on the display surface is generated by using the stereoscopic object having been subjected to the scaling transformation, and the stereoscopic image is displayed on the display surface. The present disclosure can be applied to, for example, an image processing device, an electronic device, an image processing method, or a program or the like.

### TECHNICAL FIELD

The present disclosure relates to an image processing device and method, and particularly relates to an image processing device and method that can suppress degradation in the stereoscopic effect and visibility of a stereoscopic image and suppress an accommodative-convergence conflict.

### BACKGROUND ART

Conventionally, spatial reproduction display devices have been developed to display stereoscopic objects viewable in stereoscopic vision (e.g., see PTL 1). The spatial reproduction display device has a display surface serving as the light source of a stereoscopic image and displays a stereoscopic object as a stereoscopic image on the display surface.

### CITATION LIST

### Patent Literature

PTL 1:
WO 2018/116580

### SUMMARY

### Technical Problem

However, in the method described in PTL 1, an image of the stereoscopic object may be partially lost in the height direction as an extension of the stereoscopic object from the display surface increases, so that a conflict with a binocular parallax may degrade the stereoscopic effect or visibility. Furthermore, an accommodative-convergence conflict may increase, the conflicts occurring between the convergence of both eyes and accommodation to the display surface with respect to the stereoscopic object.

The present disclosure has been devised in view of such circumstances and is configured to suppress degradation in the stereoscopic effect and visibility of a stereoscopic image and suppress an accommodative-convergence conflict.

### Solution to Problem

An image processing device according to an aspect of the present technique is an image processing device including: a scaling transformation unit that performs scaling transformation on a stereoscopic object according to the angle of a display surface with respect to a horizontal plane of a real space; an image generation unit that generates a stereoscopic image to be displayed on the display surface, by using the stereoscopic object having been subjected to the scaling transformation; and a display control unit that displays the stereoscopic image on the display surface.

An image processing method according to an aspect of the present disclosure is an image processing method including: performing scaling transformation on a stereoscopic object according to the angle of a display surface with respect to a horizontal plane of a real space; generating a stereoscopic image to be displayed on the display surface, by using the stereoscopic object having been subjected to the scaling transformation; and displaying the stereoscopic image on the display surface.

In the image processing device and method according to an aspect of the present technique, scaling transformation is performed on a stereoscopic object according to the angle of a display surface with respect to a horizontal plane of a real space, a stereoscopic image to be displayed on the display surface is generated by using the stereoscopic object having been subjected to the scaling transformation, and the stereoscopic image is displayed on the display surface.

### BRIEF DESCRIPTION OF DRAWINGS

FIG. 1 is an explanatory drawing illustrating an example of a method for displaying a stereoscopic image.

FIG. 2 is a block diagram illustrating a main configuration example of a spatial reproduction display system.

FIG. 3 illustrates an example of the appearance overview of a display unit.

FIG. 4 illustrates an example of the appearance overview of the display unit.

FIG. 5 is an explanatory drawing of a display example of a stereoscopic image.

FIG. 6 illustrates an example of the appearance overview of the display unit.

FIG. 7 illustrates an example of the appearance overview of the display unit.

FIG. 8 is an explanatory drawing illustrating an example of a partial loss of an image of a stereoscopic object.

FIG. 9 is an explanatory drawing illustrating an example of a partial loss of an image of the stereoscopic object.

FIG. 10 is an explanatory drawing illustrating an example of scaling transformation of the stereoscopic object.

FIG. 11 is an explanatory drawing illustrating an example of scaling transformation of the stereoscopic object.

FIG. 12 is a flowchart for explaining an example of the flow of spatial reproduction display processing.

FIG. 13 is a block diagram illustrating another configuration example of the spatial reproduction display system.

FIG. 14 is an explanatory drawing of a control example of a display surface angle.

FIG. 15 is an explanatory drawing of a control example of the display surface angle.

FIG. 16 is a flowchart for explaining another example of the flow of spatial reproduction display processing.

FIG. 17 is a block diagram illustrating another configuration example of the spatial reproduction display system.

FIG. 18 is an explanatory drawing illustrating clipping of the stereoscopic object.

FIG. 19 is an explanatory drawing illustrating clipping of the stereoscopic object.

FIG. 20 is an explanatory drawing illustrating clipping of the stereoscopic object.

FIG. 21 is a flowchart for explaining another example of the flow of spatial reproduction display processing.

FIG. 22 is a block diagram illustrating a main configuration example of a computer.

### DESCRIPTION OF EMBODIMENTS

Hereinafter, modes for carrying out the present disclosure (hereinafter referred as embodiments) will be described. The descriptions will be given in the following order.
1. Display of Stereoscopic Image
2. First Embodiment (Scaling Transformation)
3. Second Embodiment (Display Surface Angle Control)
4. Third Embodiment (Clipping)
5. Supplementary Notes

### <1. Display of Stereoscopic Image>

### <Literatures Supporting Technical Contents and Terms>

The scope disclosed in the present technique is not limited to the contents described in embodiments and also includes contents described in PTL 1 below that was known at the time of filing and the contents of other literatures referred to in PTL 1 below.

### PTL 1: (Described Above)

In other words, the contents in PTL 1 and the contents of other literatures referred to in the foregoing PTL 1 are also grounds for determining support requirements.

### <Spatial Reproduction Display>

Conventionally, spatial reproduction display devices have been developed to display stereoscopic objects viewable in stereoscopic vision as described in, for example, PTL 1. The spatial reproduction display device has a display surface serving as the light source of a stereoscopic image and displays a stereoscopic object as a stereoscopic image on the display surface.

However, in the method described in PTL 1, an image of the stereoscopic object may be partially lost in the height direction as an extension of the stereoscopic object from the display surface increases. This may cause a visual conflict between a parallax and a two-dimensional occlusion cue, resulting in degradation in stereoscopic effect. Furthermore, the visibility may also decrease. Moreover, the parallax amount may increase with a distance from the display surface. This may increase an accommodative-convergence conflict.

Convergence indicates inward and outward movements of eyeballs when a subject is being viewed from both eyes. Accommodation indicates a change of the thickness of a crystalline lens in an eyeball, the change being made to achieve a focus on a viewing subject. An accommodative-convergence conflict indicates a conflict between these movements.

Generally, convergence and accommodation are both performed at the same time when a subject is viewed. In the real world, an angle of convergence and an amount of accommodation for changing the thickness of a crystalline lens are in proportion to each other. In contrast, when a stereoscopic image is viewed, accommodation is performed on a display surface while convergence is performed on a stereoscopic object. Thus, as the sense of depth and the position of the display surface separate from each other, an accommodative-convergence conflict may increase and cause eyestrain. In other words, as the parallax amount of a stereoscopic image increases, an accommodative-convergence conflict may increase.

### 2. First Embodiment

### <Scaling Transformation of Stereoscopic Object>

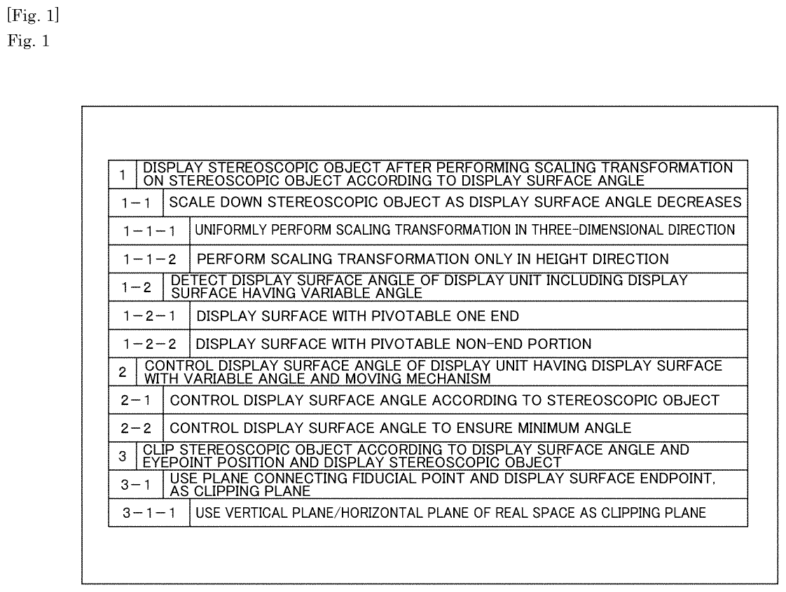

Thus, as indicated in the uppermost row of a table in FIG. 1, scaling transformation is performed on a stereoscopic object according to a display surface angle, and then the object is displayed (method 1). Scaling transformation is processing for transforming the scale (size) of a stereoscopic object. This can reduce a partial loss of an image, thereby suppressing degradation in the stereoscopic effect and visibility of a stereoscopic image. Furthermore, an increase in parallax amount can be reduced, thereby suppressing an accommodative-convergence conflict.

### <Spatial Reproduction Display System>

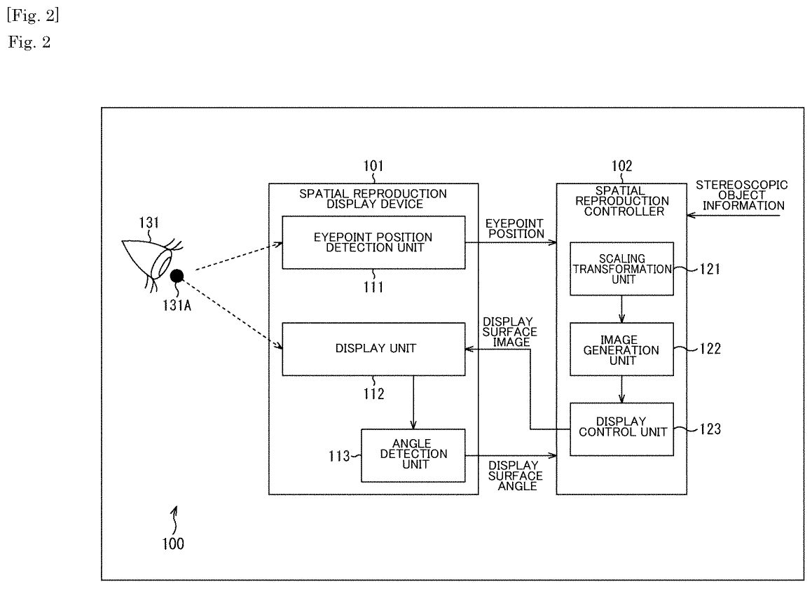

FIG. 2 is a block diagram illustrating an example of the configuration of a spatial reproduction display system that is an aspect of an image processing device to which the present technique is applied. A spatial reproduction display system 100 in FIG. 2 is a system for displaying a stereoscopic image. The spatial reproduction display system 100 displays a stereoscopic image according to the present technique.

FIG. 2 illustrates main processing units and data flows. The present disclosure is not limited to those illustrated in FIG. 2. In other words, the spatial reproduction display system 100 may include devices and processing units that are not illustrated as blocks in FIG. 2. Moreover, the system may include data flows and processing that are not indicated as arrows or the like in FIG. 2.

As illustrated in FIG. 2, the spatial reproduction display system 100 includes a spatial reproduction display device 101 and a spatial reproduction controller 102. The spatial reproduction display device 101 is a device for displaying a stereoscopic image. The spatial reproduction controller 102 is a device for performing processing for controlling the display of a stereoscopic image by means of the spatial reproduction display device 101. The spatial reproduction display device 101 and the spatial reproduction controller 102 are connected to communicate with each other and can perform wire communications or radio communications or both of wire and radio communications.

For example, the spatial reproduction controller 102 may acquire a stereoscopic object as contents (3D data) to be displayed as a stereoscopic image, generate a stereoscopic image by using the stereoscopic object, supply the stereoscopic image as a display surface image to the spatial reproduction display device 101, and display the image. The display surface image indicates an image to be displayed on the display surface. Under the control of the spatial reproduction controller 102, the spatial reproduction display device 101 may display the display surface image (stereoscopic image) supplied from the spatial reproduction controller 102. Therefore, the spatial reproduction display device 101 and the spatial reproduction controller 102 may be referred to as image processing devices.

The spatial reproduction display device 101 includes an eyepoint position detection unit 111, a display unit 112, and an angle detection unit 113. The spatial reproduction controller 102 includes a scaling transformation unit 121, an image generation unit 122, and a display control unit 123.

The eyepoint position detection unit 111 performs processing for the position of an eyepoint 131A (eyepoint position) of an observer 131 who is observing a stereoscopic image. The eyepoint position detection unit 111 has a device for detecting an eyepoint position. For example, the eyepoint position detection unit 111 may include a camera, a depth camera, a human detecting sensor, or a combination thereof as the device of the eyepoint position detection unit 111. In this case, one or more of the devices including a camera, a depth camera, and a human detecting sensor may be provided. The eyepoint position detection unit 111 may detect the eyepoint position of the observer 131 by using such a device. The eyepoint 131A may indicate the right eye, the left eye, or both eyes of the observer 131. The eyepoint position detection unit 111 may also detect the line of sight of the observer 131. The eyepoint position detection unit 111 may supply information about the detected eyepoint position to the spatial reproduction controller 102.

The display unit 112 performs processing for the display of a stereoscopic image. The display unit 112 includes a display device (e.g., a glasses-free 3D display) that displays a stereoscopic image on the display surface. For example, the display unit 112 may acquire a display surface image (stereoscopic image) supplied from the display control unit 123. Moreover, the display unit 112 may display the acquired display surface image (stereoscopic image) on the display surface of the display device. The observer 131 observes the stereoscopic image, which is displayed on the display surface, from the eyepoint position.

The angle detection unit 113 performs processing for the detection of the display surface angle of the display unit 112. The display surface angle indicates the angle of the display surface of the display unit 112 with respect to the horizontal plane of a real space. The angle detection unit 113 has a device for detecting a display surface angle. For example, the angle detection unit 113 may include an acceleration sensor, a gyroscope sensor, a magnetic sensor, or a combination thereof as the device of the angle detection unit 113. In this case, one or more of the devices including an acceleration sensor, a gyroscope sensor, and a magnetic sensor may be provided. The angle detection unit 113 may also detect a display surface angle with a mechanical structure. The angle detection unit 113 may detect the display surface angle of the display unit 112 by using such devices. The angle detection unit 113 may supply information about the detected display surface angle to the spatial reproduction controller 102.

The scaling transformation unit 121 performs processing for scaling transformation. The scaling transformation unit 121 may acquire a stereoscopic object supplied to the spatial reproduction controller 102. Moreover, the scaling transformation unit 121 may acquire a display surface angle supplied from the angle detection unit 113. Furthermore, the scaling transformation unit 121 may perform scaling transformation on the acquired stereoscopic object according to the acquired display surface angle. The scaling transformation unit 121 may supply the stereoscopic object having been subjected to scaling transformation, to the image generation unit 122.

The image generation unit 122 performs processing for the generation of a display surface image (stereoscopic image). For example, the image generation unit 122 may acquire a stereoscopic object supplied from the scaling transformation unit 121. Moreover, the image generation unit 122 may acquire information about an eyepoint position from the eyepoint position detection unit 111. Furthermore, the image generation unit 122 may acquire information about a display surface angle from the angle detection unit 113. For example, the image generation unit 122 may render the acquired stereoscopic object in a rendering space. Moreover, the image generation unit 122 may virtually generate an eyepoint image (also referred to as a virtual eyepoint image) by orthogonal projection on the image of the rendered stereoscopic object according to the acquired eyepoint position that serves as a virtual eyepoint. The eyepoint image indicates an image viewed from a certain eyepoint. At this point, the image generation unit 122 may generate a virtual eyepoint image for each of the left eye and the right eye (a left-eye image and a right eye image). Moreover, the image generation unit 122 may transform the virtual eyepoint image to a display surface image by projecting the generated virtual eyepoint image from the eyepoint position to the display surface on the basis of the acquired display surface angle. The image generation unit 122 may supply the generated display surface image to the display control unit 123.

The display control unit 123 performs processing for the control of the display of a stereoscopic image. For example, the display control unit 123 may acquire a display surface image (stereoscopic image) supplied from the image generation unit 122. Moreover, the display control unit 123 may generate a light source image for display from the acquired display surface image and supply the image to the display unit 112. The light source image for display is control information that allows the display unit 112 to display the display surface image. The display unit 112 is driven according to the light source image for display, so that the display surface image can be displayed on the display surface.

### <Display Unit>

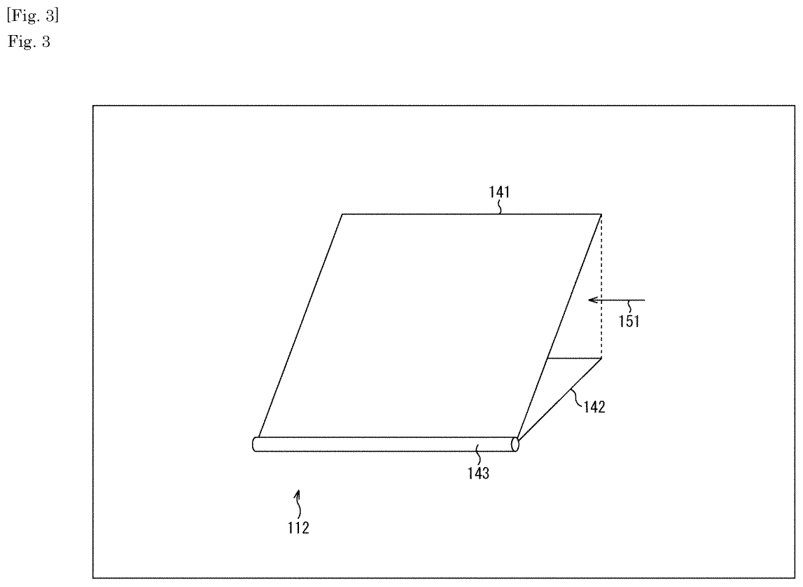

The display unit 112 will be described below. FIG. 3 is an outside drawing for explaining the main configuration example of the display unit 112. For example, as illustrated in FIG. 3, the display unit 112 may include a display surface 141, a fixed portion 142, and a hinge portion 143.

The display surface 141 has a display device capable of displaying a stereoscopic image and displays a display surface image by driving the display device according to the control of the spatial reproduction controller 102 (a light source image for display from the spatial reproduction controller 102). The fixed portion 142 is a portion to be fixed to another object. The fixed portion 142 is fixed to be a horizontal plane of a real space. The hinge portion 143 is configured to connect the display surface 141 and the fixed portion 142. The display surface 141 is connected to the fixed portion 142 via the hinge portion 143 so as to pivot with respect to the fixed portion 142.

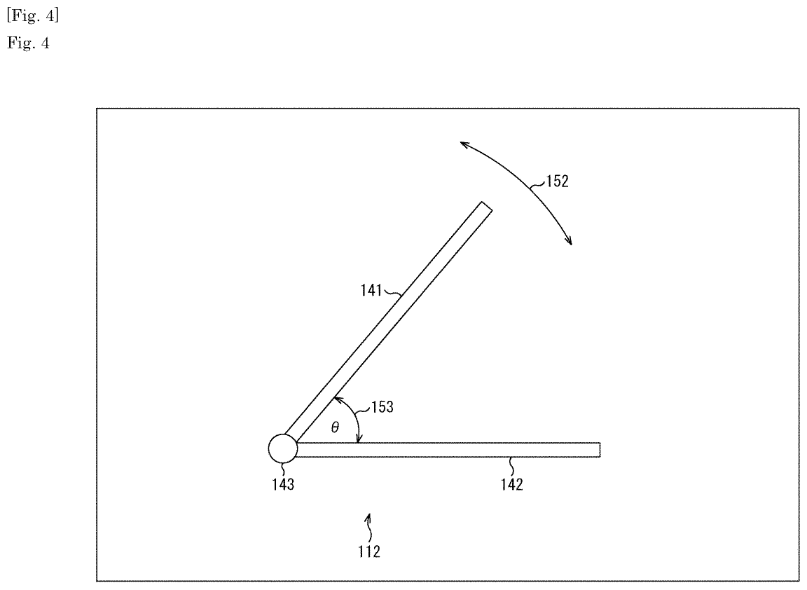

FIG. 4 illustrates an example of the outside drawing of the display unit 112 viewed in the direction of an arrow 151 (lateral direction in FIG. 3). As illustrated in FIG. 4, the hinge portion 143 is provided at one end (the lower end in FIG. 4) of the display surface 141. In other words, the display surface 141 is connected at the lower end to the fixed portion 142. The fixed portion 142 is fixed along a horizontal plane of a real space. Thus, as indicated by a double-pointed arrow 153, an angle θ of the display surface 141 with respect to the fixed portion 142 serves as a display surface angle. As indicated by a double-pointed arrow 152, the display surface 141 can pivot about the hinge portion 143 with respect to the fixed portion 142. Thus, the display surface angle θ is variable. The angle detection unit 113 in FIG. 2 detects the display surface angle θ.

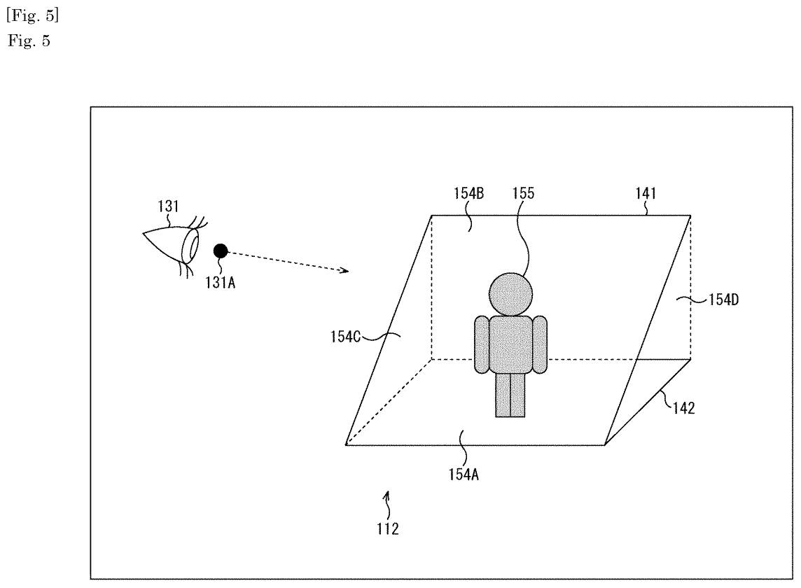

FIG. 5 illustrates an example of a state of a stereoscopic image displayed by the display unit 112. For example, the display unit 112 displays a display surface image (stereoscopic image) including a stereoscopic object 155 on the display surface 141. The display surface image (stereoscopic image) is configured with a left eye image and a right-eye image with a parallax. Because of the parallax, the stereoscopic object 155 (stereoscopic image) is viewed from the eyepoint 131A of the observer 131 such that the stereoscopic object 155 stands in a virtual space surrounded by a floor surface 154A, a back wall surface 154B, a left wall surface 154C, and a right wall surface 154D.

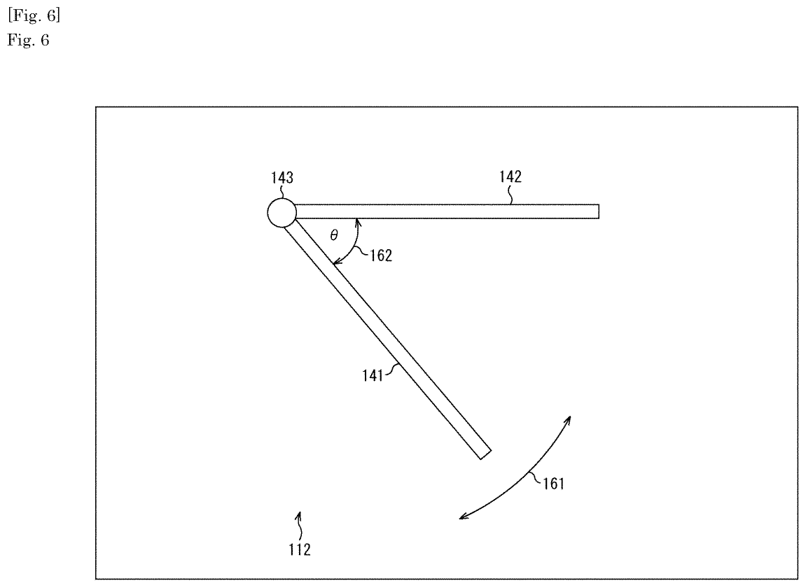

In FIG. 4, the hinge portion 143 is provided at the lower end of the display surface 141. However, the hinge portion 143 may be located at any position. For example, as illustrated in FIG. 6, the hinge portion 143 may be provided at the upper end of the display surface 141. In this case, the display surface 141 is connected at the upper end to the fixed portion 142. As indicated by a double-pointed arrow 162, an angle θ of the display surface 141 with respect to the fixed portion 142 serves as a display surface angle. Moreover, as indicated by a double-pointed arrow 161, the display surface 141 can pivot about the upper end (the hinge portion 143 at the upper end) with respect to the fixed portion 142. Thus, the display surface angle θ is variable. The angle detection unit 113 in FIG. 2 detects the display surface angle θ.

In other words, when the foregoing method 1 is applied, the display unit 112 may have a variable display surface angle as indicated in the fifth row from the top of the table in FIG. 1. The angle detection unit 113 may detect the display surface angle (method 1-2).

When the method 1-2 is applied, one end of the display surface 141 may be pivotable as indicated in the sixth row from the top of the table in FIG. 1 (method 1-2-1). The lower end of the display surface 141 may be pivotable as in example of FIG. 4, or the upper end of the display surface 141 may be pivotable as in the example of FIG. 6.

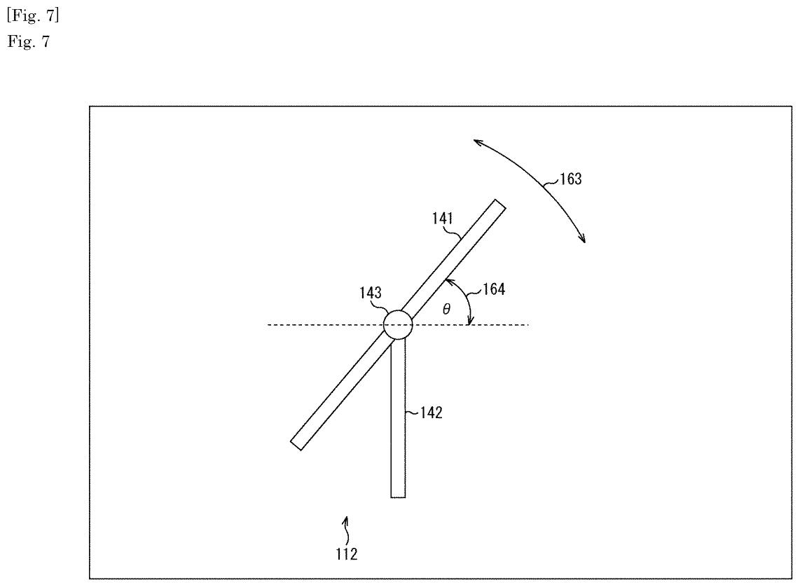

When the method 1-2 is applied, a non-end portion (a portion other than the ends) of the display surface 141 may be pivotable as indicated in the seventh row from the top of the table in FIG. 1 (method 1-2-2). In other words, the hinge portion 143 may be provided at a portion other than the ends of the display surface 141. FIG. 7 shows an example. In the case of the example in FIG. 7, the fixed portion 142 is fixed to be a vertical plane of a real space. The hinge portion 143 is provided at the central portion (non-end portion) of the display surface 141. The display surface 141 is connected via the hinge portion 143 to the fixed portion 142 so as to pivot with respect to the fixed portion 142. As indicated by a double-pointed arrow 164, an angle θ of the display surface 141 with respect to a horizontal plane (dotted line) of a real space serves as a display surface angle. As indicated by a double-pointed arrow 163, the display surface 141 can pivot about the hinge portion 143 with respect to the fixed portion 142. Thus, the display surface angle θ is variable. The angle detection unit 113 in FIG. 2 detects the display surface angle θ.

The foregoing configuration examples are exemplarily described. The display unit 112 may have any configuration and is not limited to these examples.

### <Scaling Transformation>

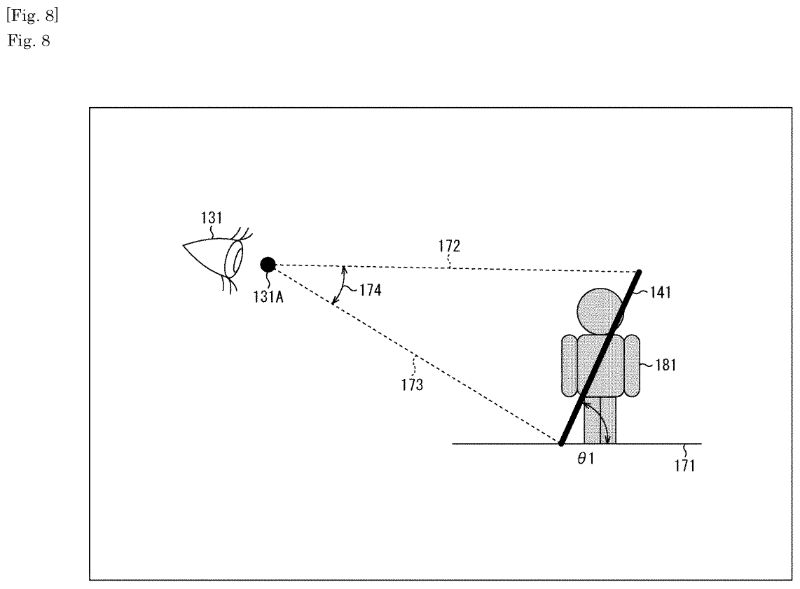

For example, as illustrated in FIG. 8, it is assumed that the display surface 141 displays a display surface image and the observer 131 is viewing a stereoscopic object 181 standing at the display surface 141 on a floor surface 171 parallel to a horizontal plane of a real space the observer 131. Moreover, the display surface angle is θ1. In this case, a range between a dotted line 172 connecting the eyepoint 131A and the upper end of the display surface 141 and a dotted line 173 connecting the eyepoint 131A and the lower end of the display surface 141 (a range indicated by a double-pointed arrow 174) is the range of the display surface 141 viewed from the observer 131. In the case of the example of FIG. 8, the stereoscopic object 181 is placed in this range (in the display surface 141) when viewed from the eyepoint 131A of the observer 131, so that the observer 131 views the stereoscopic object 181 as a stereoscopic image.

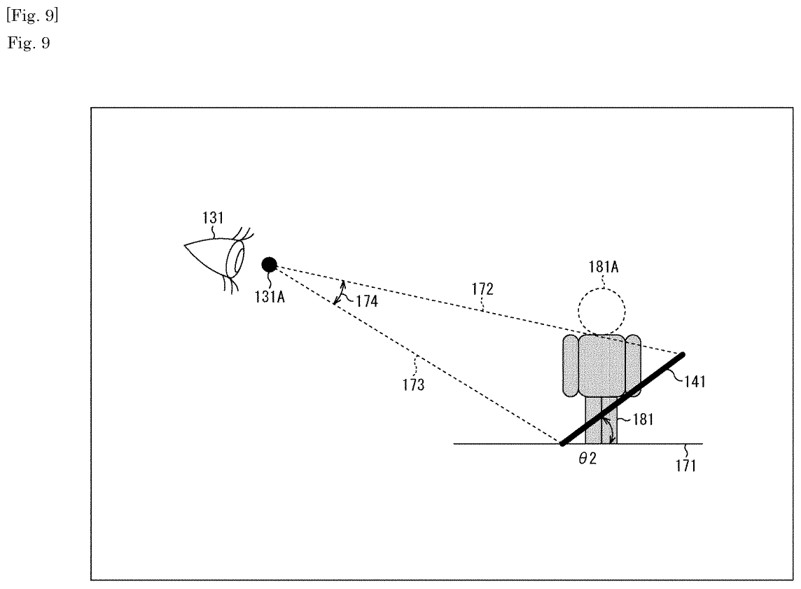

Furthermore, as in an example illustrated in FIG. 9, the display surface 141 is tilted to reduce the display surface angle (the display surface 141 is oriented close to the horizontal plane of the real space). The display surface angle in FIG. 9 is θ2 (θ2<θ1). As the display surface angle decreases, the range of the display surface 141 viewed from the observer 131 (a range indicated by a double-pointed arrow 174) narrows. In the case of the example in FIG. 9, a head portion 181A of the stereoscopic object 181 is located above the dotted line 172 and is placed out of the range of the display surface 141 viewed from the observer 131.

As described above, as the display surface angle decreases, the stereoscopic object 181 extends from the display surface 141, so that an image of the stereoscopic object 181 may be partially lost in relation to the eyepoint position of the observer 131. If an image of the stereoscopic object 181 is partially lost, a conflict with a binocular parallax may degrade the stereoscopic effect or visibility. This may also increase an accommodative-convergence conflict. An increased accommodative-clothes conflict may cause eyestrain of the observer 131.

Hence, the method 1 is applied and the scaling transformation unit 121 performs scaling transformation on a stereoscopic object according to the display surface angle. Specifically, the scaling transformation unit 121 sets a scale value of scaling transformation according to the display surface angle. The scale value indicates the ratio of a scale after transformation to a scale before transformation. For example, when the method 1 is applied, as indicated in the second row from the top of the table in FIG. 1, the scaling transformation unit 121 may reduce the scale of the stereoscopic object as the display surface angle decreases (as the display surface approaches the horizontal plane). In other words, the scaling transformation unit 121 may increase the scale of the stereoscopic object as the display surface angle increases (as the display surface moves away from the horizontal plane) (method 1-1).

Thereafter, the image generation unit 122 generates a display surface image (a stereoscopic image to be displayed on the display surface 141) by using the stereoscopic object having been subjected to the scaling transformation, and the display control unit 123 displays the display surface image on the display surface 141 of the display unit 112.

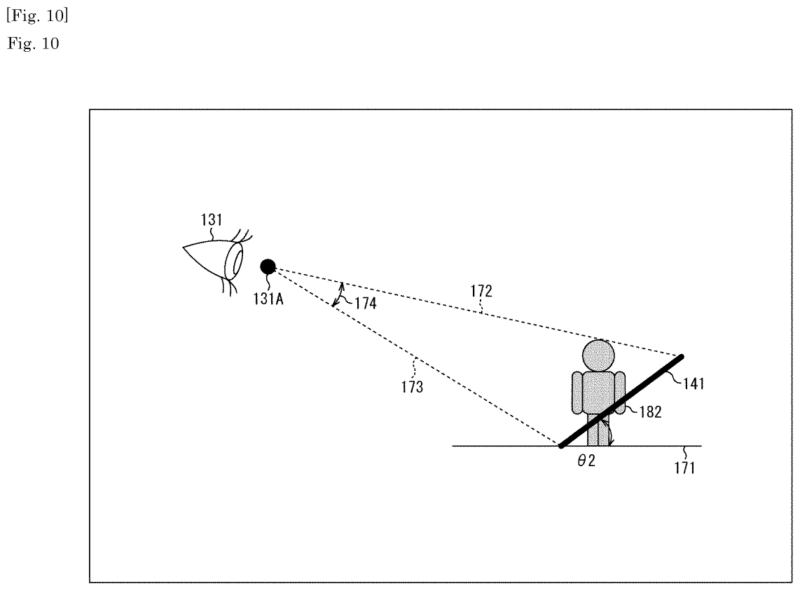

Thus, the display unit 112 displays the display surface image including a stereoscopic object 182, which is scaled down according to the display surface angle θ2, as exemplarily illustrated in FIG. 10. Hence, as illustrated in the example of FIG. 10, the stereoscopic object 182 standing at the display surface 141 on the floor surface 171 is viewed from the eyepoint 131A of the observer 131. In short, the stereoscopic object 182 is placed in the range of the display surface 141 viewed from the observer 131. Therefore, the stereoscopic object 182 does not extend from the display surface 141, resulting in no partial loss of an image of the stereoscopic object 182. In other words, scaling transformation on a stereoscopic object by the scaling transformation unit 121 allows the spatial reproduction display system 100 to suppress a partial loss of an image of the stereoscopic object. Hence, the spatial reproduction display system 100 can suppress degradation in the stereoscopic effect and visibility of a stereoscopic image. Furthermore, the spatial reproduction display system 100 can reduce an increase in parallax amount, thereby suppressing an accommodative-convergence conflict.

When the method 1-1 is applied in the scaling transformation, the scaling transformation unit 121 may uniformly perform scaling transformation in a three-dimensional direction as indicated in the third row from the top of the table in FIG. 1 (method 1-1-1). In other words, the scaling transformation unit 121 may perform scaling transformation in the height direction and the width direction to keep the ratio of the height and the width of a stereoscopic object.

When the method 1-1 is applied in the scaling transformation, the scaling transformation unit 121 may perform scaling transformation only in the height direction as indicated in the fourth row from the top of the table in FIG. 1 (method 1-1-2). In other words, the ratio of the height and the width of a stereoscopic object does not need to be kept in scaling transformation.

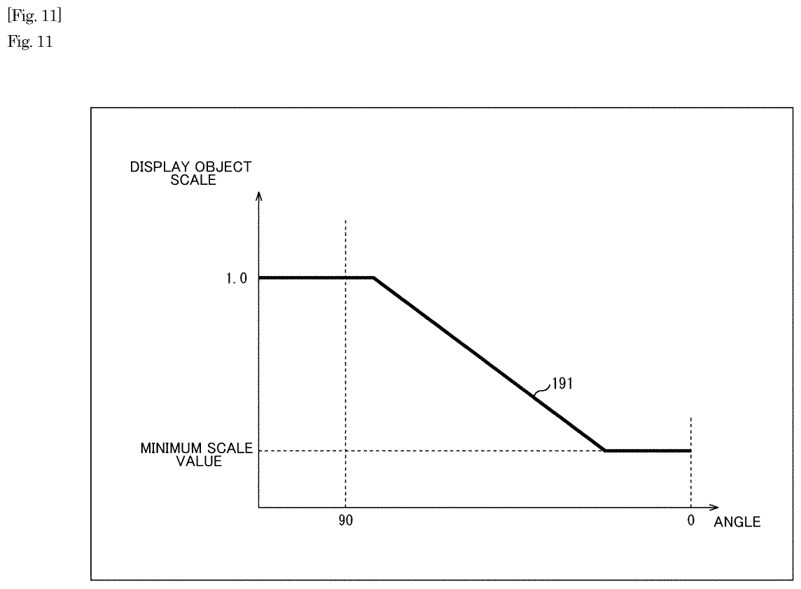

A graph in FIG. 11 shows an example of the relationship between a surface display angle and a scale value in scaling transformation. The horizontal axis indicates a surface display angle. The vertical axis indicates a scale value. The scaling transformation unit 121 transforms a scale of a stereoscopic object before transformation to a scale after transformation.

In the case of the example in FIG. 11, a scale value corresponding to a display surface angle changes as indicated by a solid line 191. When the display surface angle is around 90° and the display surface 141 is substantially perpendicular to a horizontal plane of a real space, that is, the display surface angle is equal to or larger than a first threshold value, the scale value is 1. In short, in this case, a scale is not changed by scaling transformation. In other words, scaling transformation is not substantially performed. When the display surface angle is smaller than the first threshold value and is equal to or larger than a second threshold value smaller than the first threshold value, the scale value decreases in proportion to the display surface angle. In short, in this case, scale transformation is performed using a scale value corresponding to a display surface angle. When the display surface angle is around 0° and the display surface 141 is substantially parallel to a horizontal plane of a real space, that is, the display surface angle is smaller than the second threshold value, the scale value is minimized. In short, in this case, scale transformation is performed using the minimum scale value.

By setting a scale value on the basis of such information, the scaling transformation unit 121 can change the scale value according to a display surface angle. For example, the scaling transformation unit 121 can scale down a stereoscopic object as the display surface angle decreases. Furthermore, the scaling transformation unit 121 can scale up a stereoscopic object as the display surface angle increases.

A scale value changes in any range of display surface angles. A scale value may change over the range of values of display surface angles (the moving range of the display surface 141) or as shown in the example of FIG. 11, a scale value may change on a part of the range. Moreover, a scale value changes in any state according to the display surface angle (a scale value corresponds to a display surface angle). A scale value may decrease in proportion to a display surface angle as in the example in FIG. 11, or a scale value may change along the solid line 191 shaped like a curve. The minimum scale value is any value smaller than 1.

A scale value corresponding to a display surface angle may be provided as table information or may be derived by computing using formulas or the like. Moreover, information about the relationship between a display surface angle and a scale value (e.g., table information or formulas or the like) may be stored in the spatial reproduction controller 102 (or the scaling transformation unit 121) in advance or may be supplied from the outside of the spatial reproduction controller 102 like stereoscopic object information or the like.

In the foregoing description, the scaling transformation unit 121 sets a scale value according to a display surface angle. Alternatively, a scale value may be also set on the basis of the position of the eyepoint 131A of the observer 131. For example, the scaling transformation unit 121 may set a scale value such that a stereoscopic object is placed in the display surface 141 (in the range of the display surface 141 viewed from the observer 131) when viewed from the position of the eyepoint 131A of the observer 131, and then the scaling transformation unit 121 may perform scale transformation using the set scale value.

### <Flow of Spatial Reproduction Display Processing>

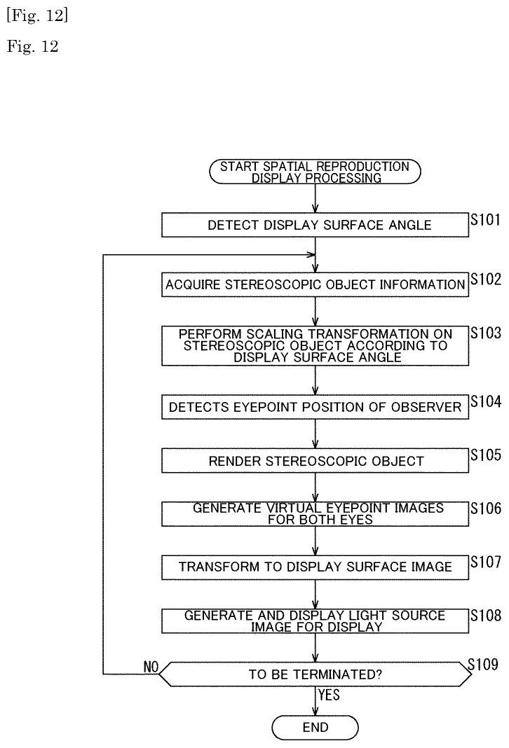

An example of the flow of spatial reproduction display processing performed by the spatial reproduction display system 100 configured thus will be described below with reference to the flowchart of FIG. 12.

When spatial reproduction display processing is started, the angle detection unit 113 detects a display surface angle in step S101. When the method 1 is applied, the display unit 112 may have a variable display surface angle and the angle detection unit 113 may detect the display surface angle while the method 1-2 is applied. When the method 1-2 is applied, one end of the display surface 141 may be pivotable according to the method 1-2-1. Moreover, the non-end of the display surface 141 may be pivotable according to the method 1-2-2.

In step S102, the spatial reproduction controller 102 acquires stereoscopic object information supplied from the outside.

In step S103, the method 1 is applied and the scaling transformation unit 121 performs scaling transformation on a stereoscopic object, which is acquired in step S102, according to the display surface angle detected in step S101.

When the method 1 is applied, the method 1-1 is applied and the scaling transformation unit 121 may scale down the stereoscopic object as the display surface angle decreases, whereas the scaling transformation unit 121 may scale up the stereoscopic object as the display surface angle increases.

When the method 1-1 is applied, the method 1-1-1 is applied and the scaling transformation unit 121 may uniformly perform scaling transformation in a three-dimensional direction. When the method 1-1 is applied, the method 1-1-2 is applied and the scaling transformation unit 121 may perform scaling transformation only in the height direction.

Furthermore, the scaling transformation unit 121 may perform scaling transformation in a predetermined range of display surface angles. The scaling transformation unit 121 may perform scaling transformation such that the stereoscopic object is placed in the display surface 141 when viewed from the eyepoint position of the observer 131.

In step S104, the eyepoint position detection unit 111 detects the eyepoint position of the observer.

In step S105, the image generation unit 122 renders the stereoscopic object in a rendering space, the stereoscopic object being subjected to scaling transformation in step S103.

In step S106, the image generation unit 122 generates virtual eyepoint images for both eyes by orthogonal projection on the image of the rendered stereoscopic object according to the eyepoint position detected in step S104, the eyepoint position serving as a virtual eyepoint.

In step S107, the image generation unit 122 transforms the virtual eyepoint image to a display surface image by projecting the virtual eyepoint image, which is generated in step S106, from the eyepoint position to the display surface on the basis of the display surface angle detected in step S101.

In step S108, the display control unit 123 generates a light source image for display from the display surface image generated in step S107, and supplies the image to the display unit 112. The display unit 112 is driven according to the light source image for display, so that the display surface image is displayed on the display surface 141.

In step S109, the spatial reproduction controller 102 determines whether to terminate the spatial reproduction display processing. If it is determined that the spatial reproduction display processing is not to be terminated, the processing returns to step S102 to perform the subsequent processing. The processing of steps S102 to S109 is repeatedly performed until it is determined in step S109 that the spatial reproduction display processing is to be terminated. When it is determined in step S109 that the spatial reproduction display processing is to be terminated, the spatial reproduction display processing is terminated.

The spatial reproduction display processing is performed thus, so that the spatial reproduction display system 100 can suppress a partial loss of an image of the stereoscopic object. Hence, the spatial reproduction display system 100 can suppress degradation in the stereoscopic effect and visibility of a stereoscopic image. Furthermore, the spatial reproduction display system 100 can reduce an increase in parallax amount, thereby suppressing an accommodative-convergence conflict.

### <Another Configuration Example>

FIG. 2 illustrates the configuration example of the spatial reproduction display system 100. The spatial reproduction display system 100 may have any configuration and is not limited to the example of FIG. 2. For example, the configuration of the spatial reproduction display device 101 may be partially or entirely integrated with the spatial reproduction controller 102. Therefore, the spatial reproduction display system 100 may be referred to as an image processing device.

For example, the spatial reproduction controller 102 may include the eyepoint position detection unit 111. Specifically, the spatial reproduction controller 102 may further include the eyepoint position detection unit 111 that detects the eyepoint position of the observer of a stereoscopic image, and the image generation unit 122 may generate a stereoscopic image (display surface image) on the basis of the eyepoint position.

Moreover, the spatial reproduction controller 102 may include the display unit 112 and the angle detection unit 113. Specifically, the spatial reproduction controller 102 may further include the display unit 112 that has the display surface 141 and the hinge portion 143 with a structure forming the display surface angle, and the angle detection unit 113 that detects the display surface angle formed by the hinge portion 143, and the scaling transformation unit 121 may perform scaling transformation according to the display surface angle detected by the angle detection unit 113. As described above, the hinge portion 143 may allow the display surface 141 to pivot about one end of the display surface 141. Furthermore, the hinge portion 143 may allow the display surface 141 to pivot about a position other than one end of the display surface 141.

Naturally, the spatial reproduction controller 102 may include all the units from the eyepoint position detection unit 111 to the angle detection unit 113. The spatial reproduction controller 102 may further include other configurations.

### 3. Second Embodiment

### <Display Surface Angle Control>

As indicated in the eighth row from the top of the table in FIG. 1, the display surface angle of a display unit having a display surface with a variable angle and a moving mechanism may be controlled in a spatial reproduction display system 100 (method 2). This method can provide display corresponding to a stereoscopic object and suppress degradation in visibility.

### <Spatial Reproduction Display System>

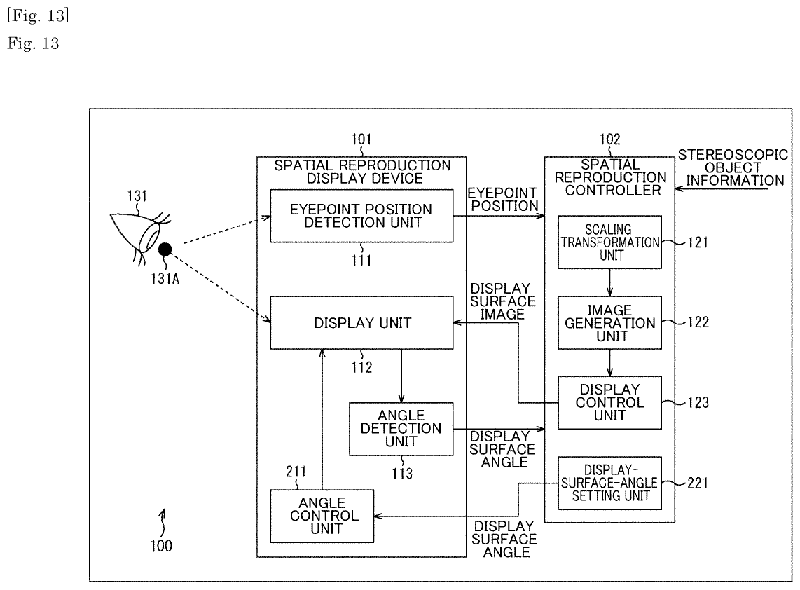

FIG. 13 is a block diagram illustrating a main configuration example of the spatial reproduction display system 100 in such a case. As illustrated in FIG. 13, in this case, a spatial reproduction display device 101 includes an angle control unit 211 in addition to the configuration of FIG. 2. Moreover, a spatial reproduction controller 102 includes a display-surface-angle setting unit 221.

The angle control unit 211 performs for the control of a display surface angle. The angle control unit 211 includes a device for controlling the orientation of a display surface 141. For example, as the device, the angle control unit 211 may include a stepping motor or a servo motor for driving a hinge portion 143. In this case, one or more devices including a stepping motor or a servo motor may be provided. The angle control unit 211 may control a display surface angle by driving the hinge portion 143 of a display unit 112 through the use of such devices and controlling the orientation (tilt) of the display surface 141. The angle control unit 211 may acquire control information about a display surface angle supplied from the display-surface-angle setting unit 221. Moreover, the angle control unit 211 may be driven on the basis of the control information to control the display surface angle.

The display-surface-angle setting unit 221 performs processing for the setting of the display surface angle. For example, the display-surface-angle setting unit 221 may set the display surface angle. Moreover, the display-surface-angle setting unit 221 may supply the control information about the set display surface angle to the angle control unit 211.

### <Method for Setting Display Surface Angle>

When the method 2 is applied, the display-surface-angle setting unit 221 may control (set) a display surface angle according to a stereoscopic object as indicated in the ninth row from the top of the table in FIG. 1 (method 2-1). For example, the display-surface-angle setting unit 221 may acquire a stereoscopic object supplied to the spatial reproduction controller 102 and set a display surface angle corresponding to the acquired stereoscopic object. Furthermore, the angle control unit 211 may control the orientation of the display surface 141 such that the display surface angle agrees with the set angle.

At this point, the display-surface-angle setting unit 221 may set the display surface angle according to the ratio of the depth and the height of the stereoscopic object. For example, the display-surface-angle setting unit 221 may set the display surface angle smaller as the depth of the stereoscopic object is larger relative to the height. In other words, the display-surface-angle setting unit 221 may set the display surface angle larger as the depth of the stereoscopic object is smaller relative to the height.

For example, the display-surface-angle setting unit 221 may set faces constituting a rectangular solid around a stereoscopic object such that the faces are in contact with the stereoscopic object in the vertical and longitudinal directions, and set the tilt of a diagonal line of a rectangle as a display surface angle in the side view of the rectangular solid. For example, the display-surface-angle setting unit 221 may derive a display surface angle according to formula (1) below.

Scale value=display surface length in longitudinal direction/diagonal line length of rectangle (1)

A value derived with a predetermined margin from formula (1) may be set as a scale value. This can provide an allowance in the upper part in the vertical direction.

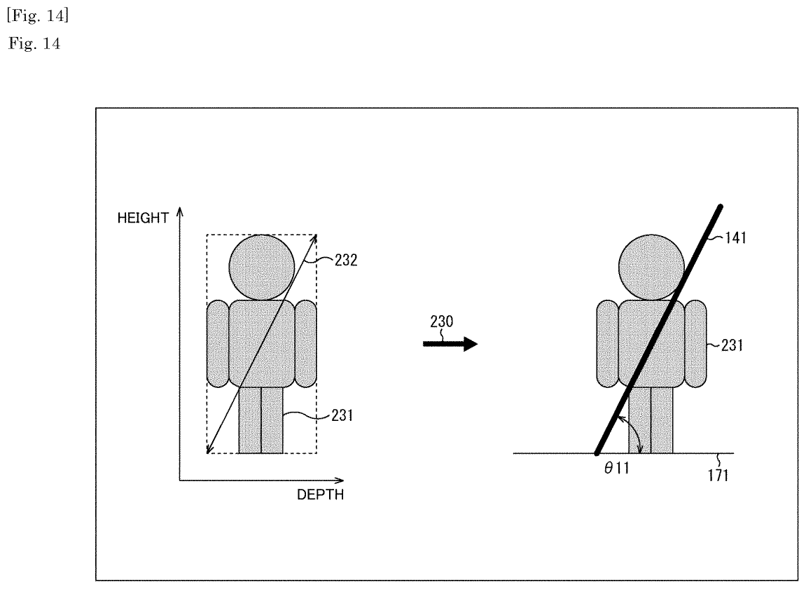

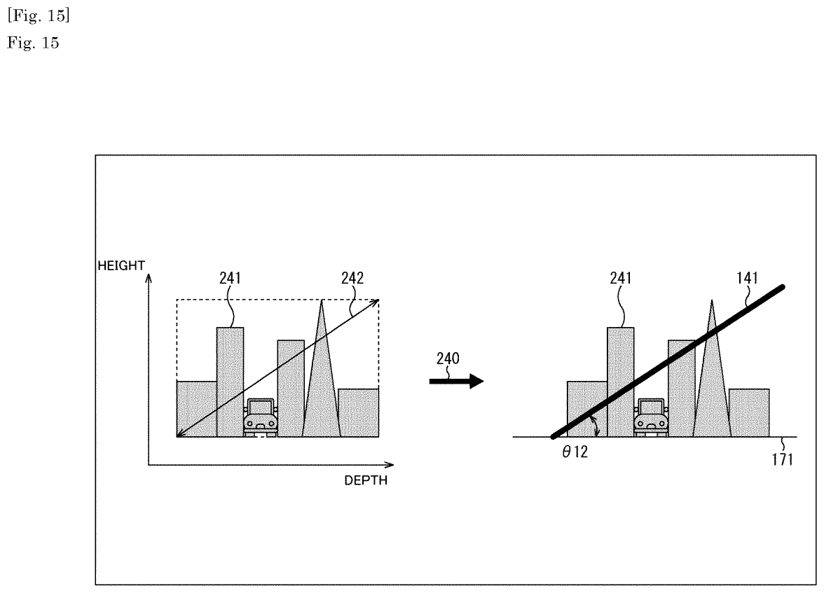

FIGS. 14 and 15 illustrate examples of the setting states of display surface angles. In FIG. 14, the display-surface-angle setting unit 221 sets a display surface angle θ11 corresponding to a stereoscopic object 231. For example, as illustrated on the left side of an arrow 230 at the center of FIG. 14, the display-surface-angle setting unit 221 determines the tilt of a diagonal line (double-pointed arrow 232) of a rectangle surrounding the stereoscopic object 231, and then the display-surface-angle setting unit 221 sets the tilt as the display surface angle θ11 as illustrated on the right side of the arrow 230. In short, θ11 is set at an angle according to the ratio of the depth and the height of the stereoscopic object 231.

In FIG. 15, the display-surface-angle setting unit 221 sets a display surface angle θ12 corresponding to a stereoscopic object 241. For example, as illustrated on the left side of an arrow 240 at the center of FIG. 15, the display-surface-angle setting unit 221 determines the tilt of a diagonal line (double-pointed arrow 242) of a rectangle surrounding the stereoscopic object 241, and then the display-surface-angle setting unit 221 sets the tilt as the display surface angle θ12 as illustrated on the right side of the arrow 240. In short, θ12 is set at an angle according to the ratio of the depth and the height of the stereoscopic object 241.

As illustrated in FIGS. 14 and 15, the stereoscopic object 241 has a large depth relative to the height as compared with the stereoscopic object 231. Thus, the display-surface-angle setting unit 221 sets θ11 at a larger value than θ12.

In this way, for example, when the stereoscopic object 231 vertically oriented with a small depth is displayed as illustrated in FIG. 14, the display-surface-angle setting unit 221 sets the display surface angle at a large value. The orientation of the display surface 141 is controlled such that the angle control unit 211 sets the display surface angle at the value, so that the stereoscopic object can be viewed at a position close to the display surface 141. This can reduce an increase in parallax amount, thereby suppressing an accommodative-convergence conflict. Moreover, the stereoscopic object can be displayed with a larger size, thereby suppressing degradation in stereoscopic effect and visibility.

When the stereoscopic object 241 displayed with a large depth over a wide range as illustrated in FIG. 15, the display-surface-angle setting unit 221 sets the display surface angle at a small value. The orientation of the display surface 141 is controlled such that the angle control unit 211 sets the display surface angle at the value, so that the stereoscopic object can be viewed at a position close to the display surface 141. This can reduce an increase in parallax amount, thereby suppressing an accommodative-convergence conflict. Moreover, the stereoscopic object can be rendered over a wider range.

### <Scaling Transformation>

The method 1 may be applied and the scaling transformation unit 121 may perform scaling transformation on a stereoscopic object according to the set display surface angle. For example, the angle detection unit 113 may detect the display surface angle controlled by the angle control unit 211, and the scaling transformation unit 121 may perform scaling transformation on the stereoscopic object according to the display surface angle.

Thus, as described in <2. First Embodiment>, the spatial reproduction display system 100 can suppress a partial loss of an image of the stereoscopic object. Hence, the spatial reproduction display system 100 can suppress degradation in the stereoscopic effect and visibility of the stereoscopic image. Furthermore, the spatial reproduction display system 100 can reduce an increase in parallax amount, thereby suppressing an accommodative-convergence conflict.

When the method 1 is applied, various methods described in <2. First Embodiment> (the method 1-1, the method 1-1-1, the method 1-1-2, the method 1-2, the method 1-2-1, the method 1-2-2, and other application examples) may be applied. When the methods are applied, the same effects as in <2. First Embodiment> can be obtained.

### <Flow of Spatial Reproduction Display Processing>

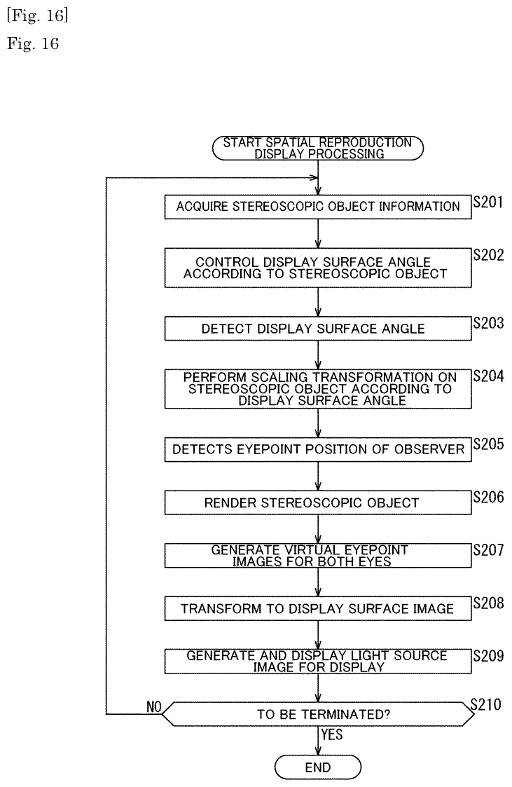

Referring to the flowchart of FIG. 16, an example of the flow of spatial reproduction display processing according to the method 2-1 will be described below.

When spatial reproduction display processing is started, in step S201, the spatial reproduction controller 102 acquires stereoscopic object information supplied from the outside.

In step S202, the method 2-1 is applied and the display-surface-angle setting unit 221 sets a display surface angle corresponding to a stereoscopic object acquired in step S201. At this point, the display-surface-angle setting unit 221 may set the display surface angle according to the ratio of the depth and the height of the stereoscopic object. For example, the display-surface-angle setting unit 221 may set the display surface angle smaller as the depth of the stereoscopic object is larger relative to the height. In other words, the display-surface-angle setting unit 221 may set the display surface angle larger as the depth of the stereoscopic object is smaller relative to the height. The angle control unit 211 controls the orientation of the display surface 141 such that the display surface angle of the display unit 112 agrees with the set angle.

In step S203, the angle detection unit 113 detects the display surface angle.

The processing of steps S204 to S210 is performed like the processing of steps S103 to S109 in FIG. 12.

In step S210, if it is determined that the spatial reproduction display processing is not to be terminated, the processing returns to step S201 to perform the subsequent processing. The processing of steps S201 to S210 is repeatedly performed until it is determined in step S210 that the spatial reproduction display processing is to be terminated. When it is determined in step S210 that the spatial reproduction display processing is to be terminated, the spatial reproduction display processing is terminated.

The spatial reproduction display processing is performed thus, so that the spatial reproduction display system 100 can reduce an increase in parallax amount, thereby suppressing an accommodative-convergence conflict. Furthermore, the spatial reproduction display system 100 can suppress a partial loss of an image of the stereoscopic object. Hence, the spatial reproduction display system 100 can suppress degradation in the stereoscopic effect and visibility of the stereoscopic image.

### <Ensuring of Minimum Angle>

When the method 2 is applied, the angle control unit 211 may control a display surface angle so as to ensure a minimum angle as indicated in the tenth row from the top of the table in FIG. 1 (method 2-2). For example, when the orientation (tilt) of the display surface 141 is controlled by an external force of a user or the like and the display surface angle is excessively reduced, an image of a stereoscopic object may be partially lost, thereby degrading the stereoscopic effect and visibility of a display surface image (stereoscopic image) displayed on the display surface 141.

Thus, the method 2-2 may be used and the angle control unit 211 may control the display surface angle so as to ensure the minimum angle. In other words, the angle control unit 211 may drive the hinge portion 143 of the display unit 112 such that the display surface angle is equal to or larger than a predetermined angle. For example, when the display surface angle is controlled by an external force of a user or the like and falls below a predetermined minimum angle, the angle control unit 211 may drive the hinge portion 143 of the display unit 112 and change the orientation (tilt) of the display surface 141 such that the display surface angle agrees with the minimum angle (the display surface angle increases). The minimum angle may be any angle. For example, the minimum angle may be an angle where the stereoscopic effect and visibility of the display surface image are not degraded. The minimum angle may be determined in advance or may be set according to a stereoscopic object or the like by, for example, the display-surface-angle setting unit 221. Thus, the spatial reproduction display system 100 can suppress a partial loss of an image of the stereoscopic object. Hence, the spatial reproduction display system 100 can suppress degradation in the stereoscopic effect and visibility of the stereoscopic image. Furthermore, the spatial reproduction display system 100 can reduce an increase in parallax amount, thereby suppressing an accommodative-convergence conflict. Moreover, a force sense of collision with a stereoscopic object can be also provided.

### <Another Configuration Example>

Also in the case of FIG. 13, the configuration of the spatial reproduction display device 101 may be partially or entirely integrated with the spatial reproduction controller 102. For example, the spatial reproduction controller 102 may include the angle control unit 211. Specifically, the spatial reproduction controller 102 may further include the display-surface-angle setting unit 221 that sets a display surface angle, and the angle control unit 211 that drives the hinge portion 143 of the display unit 112 such that the display surface angle agrees with an angle set by the display-surface-angle setting unit 221.

Naturally, the spatial reproduction controller 102 may include all the units from the eyepoint position detection unit 111 to the angle detection unit 113 and the angle control unit 211. The spatial reproduction controller 102 may further include other configurations.

### 4. Third Embodiment

### <Clipping>

In the spatial reproduction display system 100 configured thus, a stereoscopic object may be clipped and displayed according to a display surface angle and an eyepoint position as indicated in the eleventh row from the top of the table in FIG. 1 (method 3). This can reduce a partial loss of an image, thereby suppressing degradation in the stereoscopic effect and visibility of a stereoscopic image. Furthermore, an increase in parallax amount can be reduced, thereby suppressing an accommodative-convergence conflict.

### <Spatial Reproduction Display System>

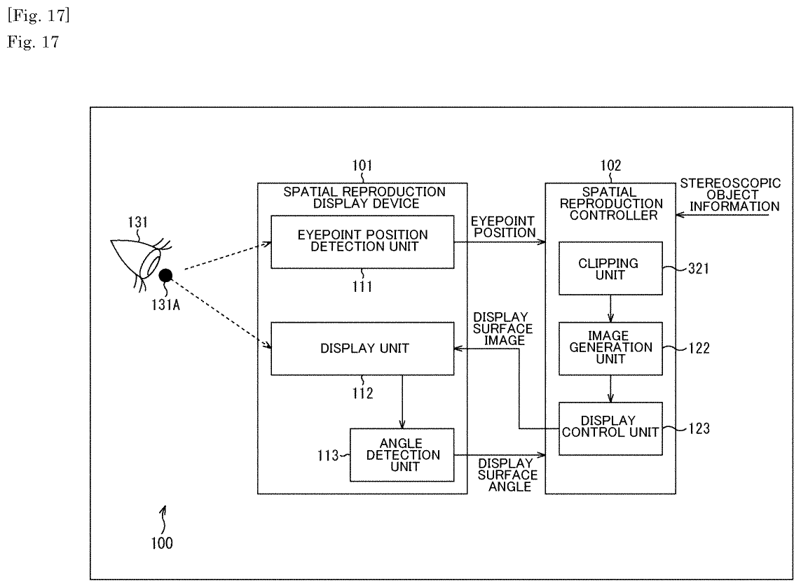

FIG. 17 is a block diagram illustrating a main configuration example of the spatial reproduction display system 100 in such a case. As illustrated in FIG. 17, in this case, the spatial reproduction controller 102 includes a clipping unit 321 instead of the scaling transformation unit 121 of the configuration in FIG. 2.

The clipping unit 321 performs processing for clipping of a stereoscopic object. For example, the clipping unit 321 may acquire a stereoscopic object supplied to the spatial reproduction controller 102. Moreover, the clipping unit 321 may acquire an eyepoint position supplied from the eyepoint position detection unit 111. Furthermore, the clipping unit 321 may acquire a display surface angle supplied from the angle detection unit 113. In addition, the clipping unit 321 may clip a part of the acquired stereoscopic object according to the acquired eyepoint position and display surface angle. Clipping is processing for cutting out a subject. For example, a part of the stereoscopic object is cut out by clipping the part. In other words, other parts are deleted. The clipping unit 321 may supply the slipped stereoscopic object to the image generation unit 122.

Specifically, in this case, the spatial reproduction controller 102 performs clipping on the stereoscopic object instead of scaling transformation of the first embodiment.

The image generation unit 122 generates a display surface image (a stereoscopic image to be displayed on the display surface 141) by using the clipped stereoscopic object, and the display control unit 123 displays the display surface image on the display surface 141 of the display unit 112.

For example, the image generation unit 122 may render the clipped stereoscopic object in a rendering space. Moreover, the image generation unit 122 may generate virtual eyepoint images for both eyes by orthogonal projection on the image of the rendered stereoscopic object according to the acquired eyepoint position that serves as a virtual eyepoint. Moreover, the image generation unit 122 may transform the virtual eyepoint image to a display surface image by projecting the generated virtual eyepoint image from the eyepoint position to the display surface on the basis of the acquired display surface angle. For example, the display control unit 123 may generate a light source image for display from the display surface image (stereoscopic image) and supply the image to the display unit 112.

### <Clipping Method>

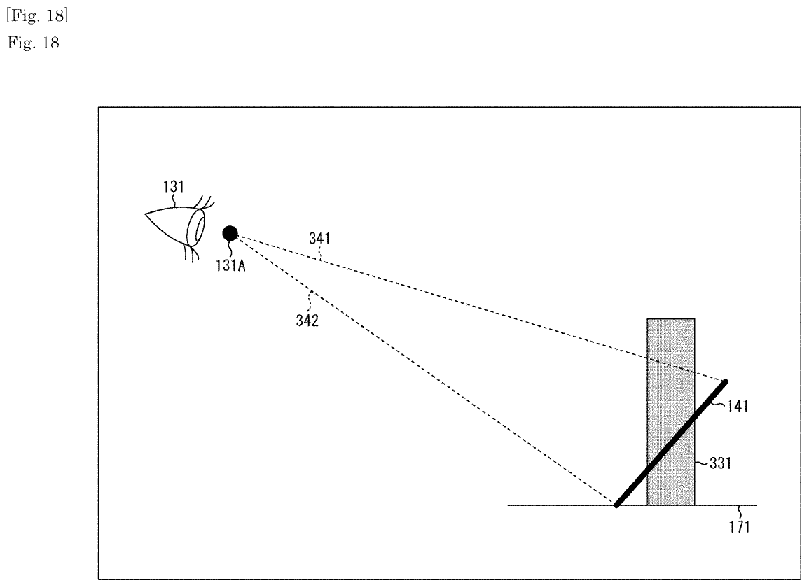

FIG. 18 illustrates an example of a state of a stereoscopic object displayed on the display surface 141. In the case of this example, as in the case of the example of FIG. 9, the observer 131 is viewing a stereoscopic object 331 at the display surface 141 on the floor surface 171 parallel to a horizontal plane of a real space. Furthermore, a range between a dotted line 341 connecting the eyepoint 131A and the upper end of the display surface 141 and a dotted line 342 connecting the eyepoint 131A and the lower end of the display surface 141 is the range of the display surface 141 viewed from the observer 131. At this point, as in the case of the example in FIG. 9, an upper portion of the stereoscopic object 331 is located above the dotted line 341 and is placed out of the range of the display surface 141 viewed from the observer 131.

When the stereoscopic object 331 extends thus from the display surface 141, an image may be partially lost to cause a visual conflict between a parallax and a two-dimensional occlusion cue, resulting in degradation in stereoscopic effect and visibility of the stereoscopic object 331.

Thus, the method 3 is applied and the clipping unit 321 clips the stereoscopic object according to the display surface angle and the eyepoint position. Specifically, the clipping unit 321 sets a clipping plane according to the display surface angle and the eyepoint position and clips the stereoscopic object on the clipping plane. The clipping surface indicates a boundary surface of a clip. In other words, the clipping unit 321 clips the stereoscopic object on the clip plane serving as a boundary (end).

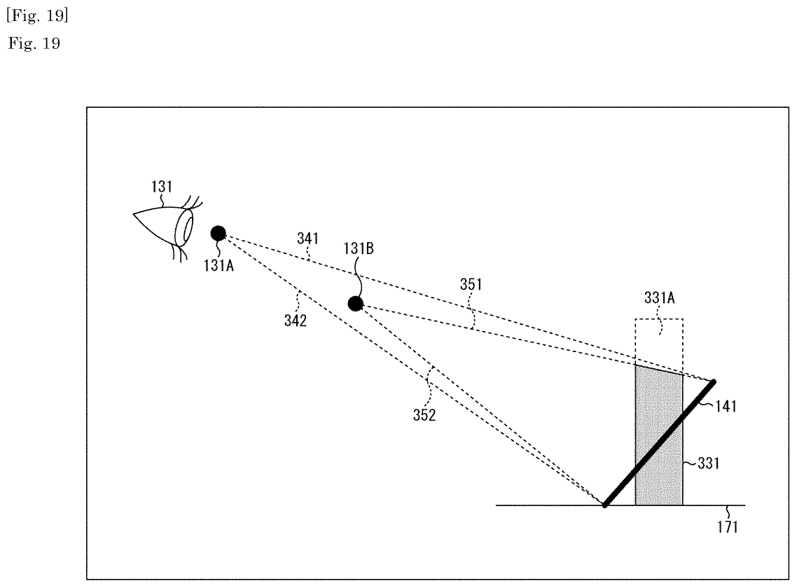

When the method 3 is applied, a plane connecting a predetermined fiducial point and a display surface endpoint may be used as a clipping plane as indicated in the twelfth row from the top of the table in FIG. 1 (method 3-1). FIG. 19 shows an example of such a state. In this case, as illustrated in FIG. 19, the clipping unit 321 may set a fiducial point 131B at a position closer to the display surface 141 than the position of the eyepoint 131A in the range of the display surface 141 viewed from the observer 131 (that is, in a range between the dotted line 341 and the dotted line 342). Moreover, the clipping unit 321 may set a plane connecting the fiducial point 131B and the display surface 141 (that is, a plane indicated as a dotted line 351, a plane indicated as a dotted line 352, or both of the lines in FIG. 19) as a clipping plane. Furthermore, the clipping unit 321 may clip the stereoscopic object 331 on the clipping plane.

Such clipping deletes an upper portion 331A (dotted frame portion) of the stereoscopic object 331. Thus, the stereoscopic object 331 is placed in the range of the display surface 141 viewed from the observer 131. Therefore, the stereoscopic object 331 does not extend from the display surface 141, resulting in no partial loss of an image of the stereoscopic object 331. In other words, clipping on the stereoscopic object by the clipping unit 321 allows the spatial reproduction display system 100 to suppress a partial loss of an image of the stereoscopic object. Hence, the spatial reproduction display system 100 can suppress degradation in the stereoscopic effect and visibility of the stereoscopic image.

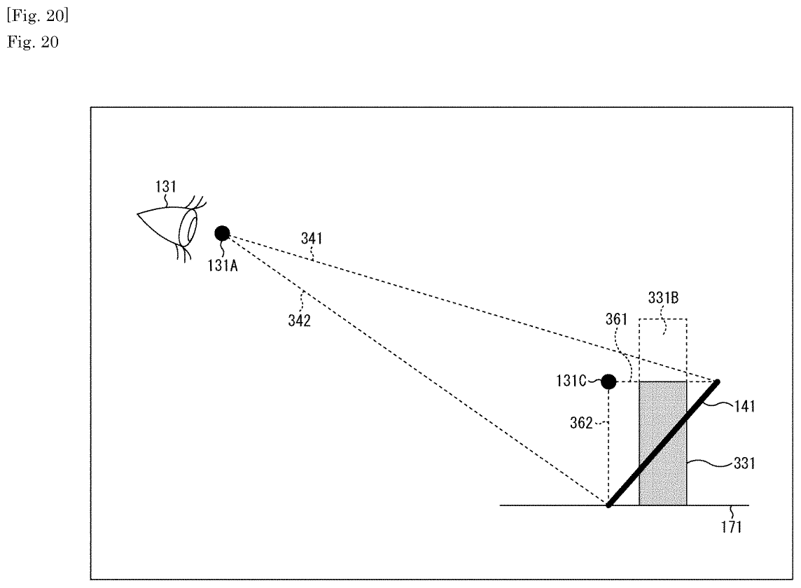

When the method 3-1 is applied, a vertical plane or a horizontal plane of a real space or each of the planes may be used as a clipping plane as indicated in the bottom row of the table in FIG. 1 (method 3-1-1). Specifically, as illustrated in FIG. 20, the clipping unit 321 sets a fiducial point 131C such that a clipping plane indicated as a dotted line 361 and a dotted line 362 serves as a vertical plane or a horizontal plane of a real space. Moreover, the clipping unit 321 may clip the stereoscopic object 331 on the clipping plane (that is, the vertical plane or the horizontal plane of the real space or each of the planes).

Such clipping deletes an upper portion 331B (dotted frame portion) of the stereoscopic object 331. Thus, the stereoscopic object 331 is placed in the range of the display surface 141 viewed from the observer 131. Therefore, the stereoscopic object 331 does not extend from the display surface 141, resulting in no partial loss of an image of the stereoscopic object 331. In other words, clipping on the stereoscopic object by the clipping unit 321 allows the spatial reproduction display system 100 to suppress a partial loss of an image of the stereoscopic object as in the case of the example of FIG. 19. Hence, the spatial reproduction display system 100 can suppress degradation in the stereoscopic effect and visibility of the stereoscopic image.

Instead of clipping on the stereoscopic object by the clipping unit 321 as described above, providing two clipping planes in front of a virtual camera for capturing a virtual eyepoint image can obtain the same effect.

### <Flow of Spatial Reproduction Display Processing>

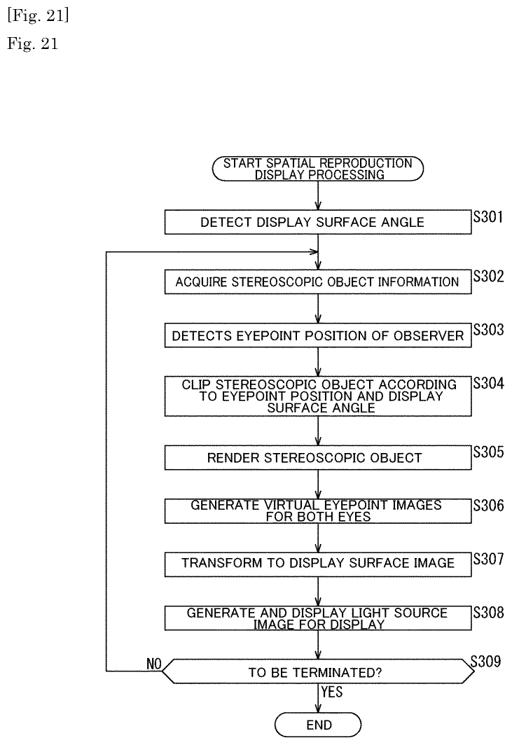

Referring to the flowchart of FIG. 21, an example of the flow of spatial reproduction display processing using the method 3 will be described below.

When spatial reproduction display processing is started, the processing of step S301 is performed like the processing of step S101 in FIG. 12, so that a display surface angle is detected. Thereafter, the processing of step S302 is performed like the processing of step S102 in FIG. 12, so that stereoscopic object information is acquired. Furthermore, the processing of step S303 is performed like the processing of step S104 in FIG. 12, so that the eyepoint position of the observer 131 is detected.

In step S304, the method 3 is applied and the clipping unit 321 sets a clipping plane according to the eyepoint position detected in step S303 and the display surface angle detected in step S301, and clips the stereoscopic object, which is acquired in step S302, on the clipping plane.

When the method 3 is applied, the method 3-1 may be applied and the clipping unit 321 may set, as a clipping plane, a plane connecting a predetermined fiducial point and a display surface endpoint. For example, the clipping unit 321 may set a fiducial point at a position closer to the display surface 141 than the eyepoint position. For example, the clipping unit 321 may set a fiducial point at a position closer to the display surface 141 than the eyepoint position in the range of the display surface 141 viewed from the observer 131. Furthermore, the clipping unit 321 may clip the stereoscopic object on a plane connecting the fiducial point and one end of the display surface.

When the method 3-1 is applied, the method 3-1-1 may be applied and the clipping unit 321 may set a vertical plane or a horizontal plane of a real space or each of the planes as a clipping plane. In other words, the clipping unit 321 may set a fiducial point such that the clipping plane is a vertical plane or a horizontal plane of a real space. Furthermore, the clipping unit 321 may clip the stereoscopic object 331 on the vertical plane or the horizontal plane of the real space or each of the planes.

The processing of steps S305 to S309 is performed like the processing of steps S105 to S109 in FIG. 12.

In step S309, if it is determined that the spatial reproduction display processing is not to be terminated, the processing returns to step S302 to perform the subsequent processing. The processing of steps S302 to S309 is repeatedly performed until it is determined in step S309 that the spatial reproduction display processing is to be terminated. When it is determined in step S309 that the spatial reproduction display processing is to be terminated, the spatial reproduction display processing is terminated.

The spatial reproduction display processing is performed thus, so that the spatial reproduction display system 100 can suppress a partial loss of an image of the stereoscopic object. Hence, the spatial reproduction display system 100 can suppress degradation in the stereoscopic effect and visibility of the stereoscopic image.

### <Another Configuration Example>

Also in this case, as in the case of the first embodiment, the spatial reproduction display system 100 may have any configuration and is not limited to the example of FIG. 17. For example, the configuration of the spatial reproduction display device 101 may be partially or entirely integrated with the spatial reproduction controller 102.

For example, the spatial reproduction controller 102 may include the eyepoint position detection unit 111. Specifically, the spatial reproduction controller 102 may further include the eyepoint position detection unit 111 that detects the eyepoint position of the observer of a stereoscopic image, the clipping unit 321 may clip a stereoscopic object according to a display surface angle and the eyepoint position, and the image generation unit 122 may generate a stereoscopic image (display surface image) on the basis of the eyepoint position.

Moreover, the spatial reproduction controller 102 may include the display unit 112 and the angle detection unit 113. Specifically, the spatial reproduction controller 102 may further include the display unit 112 that has the display surface 141 and the hinge portion 143 with a structure forming the display surface angle, and the angle detection unit 113 that detects the display surface angle formed by the hinge portion 143, and the clipping unit may clip the stereoscopic object according to the display surface angle and the eyepoint position. As described above, the hinge portion 143 may allow the display surface 141 to pivot about one end of the display surface 141. Furthermore, the hinge portion 143 may allow the display surface 141 to pivot about a position other than one end of the display surface 141.

Naturally, the spatial reproduction controller 102 may include all the units from the eyepoint position detection unit 111 to the angle detection unit 113. The spatial reproduction controller 102 may further include other configurations.

<Combined with Scaling Transformation>

Scaling transformation described in the first embodiment and clipping described in the present embodiment (third embodiment) may be both performed on a stereoscopic object. For example, the clipping unit 321 of FIG. 17 may be added to the configuration of the spatial reproduction controller 102 in FIG. 2. For example, the processing of step S304 in FIG. 21 may be performed after the processing of step S104 in the flowchart of the spatial reproduction display processing in FIG. 12.

Specifically, the clipping unit 321 may be provided for the spatial reproduction controller 102 including the scaling transformation unit 121 that performs scaling transformation on a stereoscopic object according to the angle of the display surface with respect to a horizontal plane of a real space, the image generation unit 122 that generates a stereoscopic image to be displayed on the display surface 141 by using the stereoscopic object having been subjected to the scaling transformation, and the display control unit 123 that displays the stereoscopic image on the display surface 141. The method 3 may be applied and the clipping unit 321 may clip the stereoscopic object according to the display surface angle and the eyepoint position of the observer of the stereoscopic image.

Furthermore, the method 3-1 may be applied and the clipping unit 321 may set a fiducial point at a position closer to the display surface 141 than the eyepoint position, set a plane connecting the fiducial point and one end of the display surface as a clipping plane, and clip the stereoscopic object on the clipping plane.

Furthermore, the method 3-1-1 may be applied and the clipping unit 321 may set a fiducial point such that a vertical plane or a horizontal plane of a real space or each of the planes serves as a clipping plane passing through one end of the display surface, and the clipping unit 321 may clip the stereoscopic object on the clipping plane.

As described above, through scaling transformation or clipping or both of scaling transformation and clipping on the stereoscopic object, the spatial reproduction display system 100 can suppress a partial loss of an image of the stereoscopic object. Hence, the spatial reproduction display system 100 can suppress degradation in the stereoscopic effect and visibility of the stereoscopic image.

In other words, for example, the clipping unit 321 of FIG. 2 may be added to the configuration of the spatial reproduction controller 102 in FIG. 17. For example, the processing of step S103 in FIG. 12 may be performed after the processing of step S301 in the flowchart of the spatial reproduction display processing in FIG. 21.

Specifically, the scaling transformation unit 121 may be provided for the spatial reproduction controller 102 including the clipping unit that clips a part of the stereoscopic object according to the angle of the display surface 141 with respect to a horizontal plane of a real space and the eyepoint position of the observer 131 of a stereoscopic image displayed on the display surface 141, the image generation unit that generates a stereoscopic image by using the partially clipped stereoscopic object, and the display control unit that displays the stereoscopic image on the display surface 141. The method 1 may be applied and the scaling transformation unit 121 may perform scaling transformation on the stereoscopic object according to the display surface angle.

Moreover, for example, the method 1-1 may be applied and the scaling transformation unit 121 may scale down the stereoscopic object as the display surface angle decreases, whereas the scaling transformation unit 121 may scale up the stereoscopic object as the display surface angle increases. Furthermore, the scaling transformation unit 121 may perform scaling transformation in a predetermined range of display surface angles. The scaling transformation unit 121 may perform scaling transformation such that the stereoscopic object is placed in the display surface 141 when viewed from the eyepoint position.

Moreover, for example, the method 1-1-1 may be applied and the scaling transformation unit 121 may perform scaling transformation to keep the ratio of the height and the width of the stereoscopic object. Furthermore, the method 1-1-2 may be applied and the scaling transformation unit 121 may perform scaling transformation only in the height direction of the stereoscopic object.

As described above, through scaling transformation or clipping or both of scaling transformation and clipping on the stereoscopic object, the spatial reproduction display system 100 can suppress a partial loss of an image of the stereoscopic object. Hence, the spatial reproduction display system 100 can suppress degradation in the stereoscopic effect and visibility of the stereoscopic image.

<Combined with Display Surface Angle Control>

Alternatively, control on a display surface angle in the second embodiment and clipping on the stereoscopic object in the present embodiment (third embodiment) may be both performed. For example, the angle control unit 211 of FIG. 13 may be added to the configuration of the spatial reproduction display device 101 in FIG. 17. Furthermore, the display-surface-angle setting unit 221 of FIG. 13 may be added to the configuration of the spatial reproduction controller 102 in FIG. 17. For example, the processing of step S202 in FIG. 16 may be performed after the processing of step S302 in the flowchart of the spatial reproduction display processing in FIG. 21.

Specifically, the display-surface-angle setting unit 221 may be provided for the spatial reproduction controller 102 including the clipping unit that clips a part of the stereoscopic object according to the angle of the display surface 141 with respect to a horizontal plane of a real space and the eyepoint position of the observer 131 of a stereoscopic image displayed on the display surface 141, the image generation unit that generates a stereoscopic image by using the partially clipped stereoscopic object, and the display control unit that displays the stereoscopic image on the display surface 141. The method 2 may be applied and the display-surface-angle setting unit 221 may set the display surface angle.

For example, the method 2-1 may be applied and the display-surface-angle setting unit 221 may set the display surface angle according to the stereoscopic object. For example, the display-surface-angle setting unit 221 may set the display surface angle according to the ratio of the depth and the height of the stereoscopic object. For example, the display-surface-angle setting unit 221 may set the display surface angle smaller as the depth of the stereoscopic object is larger relative to the height, whereas the display-surface-angle setting unit 221 may set the display surface angle larger as the depth of the stereoscopic object is smaller relative to the height.

The spatial reproduction controller 102 in FIG. 17 may further include the angle control unit 211 of FIG. 13. Moreover, the method 2 may be applied and the angle control unit 211 may drive the hinge portion 143 such that the display surface angle agrees with an angle set by the display-surface-angle setting unit 221.

For example, the method 2-2 may be applied and the angle control unit 211 may drive the hinge portion 143 such that the display surface angle is equal to or larger than a predetermined angle.

Thus, the spatial reproduction display system 100 obtain the same effect as in the second embodiment.

Naturally, all the configurations described in the first to third embodiments may be combined.

### <5. Supplementary Notes>

### <Computer>

The series of processing can be executed by hardware or software. When the series of processing is executed by software, a program that constitutes the software is installed on a computer. The computer includes, for example, a computer built in dedicated hardware and a general-purpose personal computer on which various programs are installed to execute various functions.

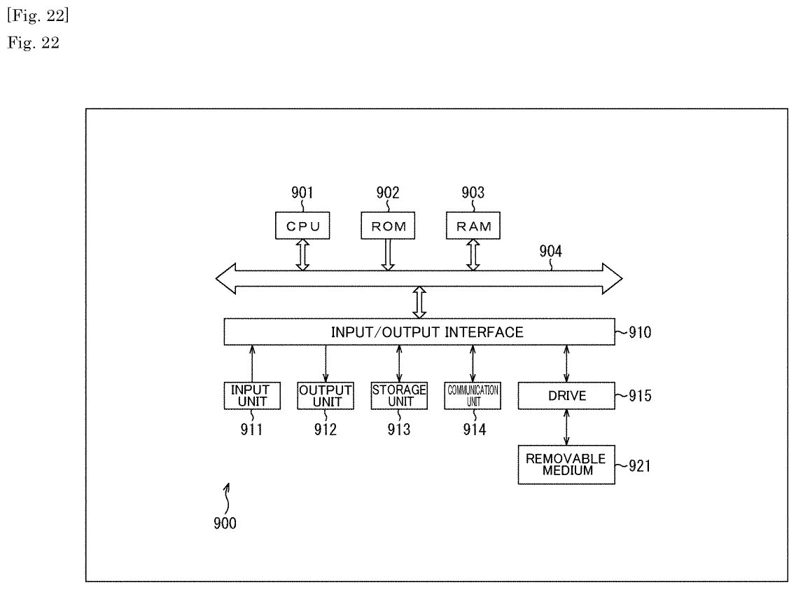

FIG. 22 is a block diagram illustrating a configuration example of the hardware of a computer that executes the series of processing according to a program.

In a computer 900 illustrated in FIG. 22, a CPU (Central Processing Unit) 901, a ROM (Read Only Memory) 902, and a RAM (Random Access Memory) 903 are connected to one another via a bus 904.

An input/output interface 910 is also connected to the bus 904. An input unit 911, an output unit 912, a storage unit 913, a communication unit 914, and a drive 915 are connected to the input/output interface 910.

The input unit 911 is configured with, for example, a keyboard, a mouse, a microphone, a touch panel, or an input terminal. The output unit 912 is configured with, for example, a display, a speaker, or an output terminal. The storage unit 913 is configured with, for example, a hard disk, a RAM disk, or non-volatile memory. The communication unit 914 is configured with, for example, a network interface. The drive 915 drives a removable medium 921 such as a magnetic disk, an optical disc, a magneto-optical disk, or a semiconductor memory.

In the computer configured thus, the CPU 901 loads a program stored in the storage unit 913 into the RAM 903 via the input/output interface 910 and the bus 904 and executes the program, so that the series of processing is performed. Data and the like necessary for the CPU 901 to execute various kinds of processing is also stored as appropriate in the RAM 903.

The program executed by the computer can be recorded and applied in, for example, the removable medium 921 as a package medium or the like. In this case, the program can be installed in the storage unit 913 via the input/output interface 910 by loading the removable medium 921 into the drive 915.

This program can also be provided via wired or wireless transfer medium such as a local area network, the Internet, and digital satellite broadcasting. In this case, the program can be received by the communication unit 914 and installed in the storage unit 913.

In addition, this program can be installed in advance in the ROM 902 or the storage unit 913.

### <Application Target of Present Technique>

The present technique can be applied to any configuration. For example, the present technique can be applied to a variety of electronic devices.

In addition, for example, the present technique can be implemented as a configuration of a part of a device such as a processor (e.g., a video processor) of a system LSI (Large Scale Integration), a module (e.g., a video module) using a plurality of processors or the like, a unit (e.g., a video unit) using a plurality of modules or the like, or a set (e.g., a video set) with other functions added to the unit.

For example, the present technique can also be applied to a network system configured with a plurality of devices. The present technique may be implemented as, for example, cloud computing for processing shared among a plurality of devices via a network. For example, the present technique may be implemented in a cloud service that provides services regarding images (moving images) to any terminals such as a computer, an AV (Audio Visual) device, a mobile information processing terminal, and an IoT (Internet of Things) device or the like.

In the present specification, a system means a set of a plurality of constituent elements (including devices and modules (parts)) regardless of whether all the constituent elements are provided in the same casing. Accordingly, a plurality of devices accommodated in separate casings and connected via a network and a single device accommodating a plurality of modules in a single casing are referred to as systems.

<Fields and Uses to which Present Technique Is Applicable>

Systems, devices, and processing units or the like to which the present technique is applied can be used in any field such as transportation, medical care, crime prevention, agriculture, livestock industry, mining, beauty, factories, home appliances, weather, and nature surveillance. The present technique can be used for any purpose.

### <Others>

The embodiments of the present technique are not limited to the above-described embodiments, and various modifications can be made without departing from the essential spirit of the present technique.

For example, a configuration described as one device (or processing unit) may be split into and configured as a plurality of devices (or processing units). Conversely, configurations described above as a plurality of devices (or processing units) may be integrated and configured as one device (or processing unit). It is a matter of course that configurations other than the aforementioned configurations may be added to the configuration of each device (or each processing unit). Moreover, some of the configurations of a certain device (or processing unit) may be included in a configuration of another device (or another processing unit) as long as the configurations and operations of the overall system are substantially identical to one another.

For example, the foregoing program may be executed by any device. In this case, the device only needs to have necessary functions (such as functional blocks) to obtain necessary information.

Moreover, for example, the steps of a flowchart may be executed by a single device or may be shared and executed by a plurality of devices. Furthermore, when a plurality of processes are included in one step, one device may execute the plurality of processes, or the plurality of devices may share and execute the plurality of processes. In other words, the plurality of processes included in one step may be executed as the processing of a plurality of steps. In contrast, processing described as a plurality of steps may be collectively executed as one step.

Furthermore, for example, in a program that is executed by a computer, processing of steps describing the program may be executed in time series in an order described in the present specification, or may be executed in parallel or individually at a required timing, for example, when a call is made. In short, the processing of the respective steps may be executed in an order different from the above-described order as long as no contradiction arises. Furthermore, the processing of the steps describing this program may be executed in parallel with processing of another program, or may be executed in combination with the processing of another program.

Moreover, for example, a plurality of techniques regarding the present technique can be independently implemented as long as no contradiction arises. Naturally, a plurality of modes of the present technique may be implemented in combination. For example, some or all of the modes of the present technique described in any one of the embodiments may be implemented in combination with some or all of the modes of the present technique described in other embodiments. Furthermore, some or all of any modes of the present technique may be implemented in combination with other techniques that not described above.

The present technique can also be configured as follows:
(1) An image processing device including: a scaling transformation unit that performs scaling transformation on a stereoscopic object according to the angle of a display surface with respect to a horizontal plane of a real space;
an image generation unit that generates a stereoscopic image to be displayed on the display surface, by using the stereoscopic object having been subjected to the scaling transformation; and
a display control unit that displays the stereoscopic image on the display surface.
(2) The image processing device according to (1), wherein the scaling transformation unit scales down the stereoscopic object as the angle decreases, whereas the scaling transformation unit scales up the stereoscopic object as the angle increases.
(3) The image processing device according to (2), wherein the scaling transformation unit performs the scaling transformation in a predetermined range of the angle.
(4) The image processing device according to any one of (1) to (3), wherein the scaling transformation unit performs the scaling transformation such that the stereoscopic object is placed in the display surface when viewed from the eyepoint position of an observer.
(5) The image processing device according to any one of (1) to (4), wherein the scaling transformation unit performs the scaling transformation to keep the ratio of the height and the width of the stereoscopic object.
(6) The image processing device according to any one of (1) to (4), wherein the scaling transformation unit performs the scaling transformation only in the height direction of the stereoscopic object.
(7) The image processing device according to any one of (1) to (6), further including a display unit that has the display surface and a structure forming the angle; and
an angle detection unit that detects the angle formed by the structure, wherein
the scaling transformation unit performs the scaling transformation according to the angle detected by the angle detection unit.
(8) The image processing device according to (7), wherein the structure allows the display surface to pivot about one end of the display surface.
(9) The image processing device according to (7), wherein the structure allows the display surface to pivot about a position other than one end of the display surface.
(10) The image processing device according to any one of (7) to (9), further including: an angle setting unit that sets the angle; and
an angle control unit that drives the structure such that the angle agrees with an angle set by the angle setting unit.
(11) The image processing device according to (10), wherein the angle setting unit sets the angle according to the stereoscopic object.
(12) The image processing device according to (11), wherein the angle setting unit sets the angle according to the ratio of the depth and the height of the stereoscopic object.
(13) The image processing device according to (12), wherein the angle setting unit sets the angle smaller as the depth is larger relative to the height.
(14) The image processing device according to any one of (10) to (13), wherein the angle control unit drives the structure such that the angle is equal to or larger than a predetermined angle.
(15) The image processing device according to any one of (1) to (14), further including a clipping unit that clips the stereoscopic object according to the angle and the eyepoint position of the observer of the stereoscopic image.
(16) The image processing device according to (15), wherein the clipping unit clips the stereoscopic object on a plane connecting a fiducial point at a position closer to the display surface than the eyepoint position and one end of the display surface.
(17) The image processing device according to (15), wherein the clipping unit clips the stereoscopic object on a vertical plane or a horizontal plane of a real space or each of the planes, the plane passing through one end of the display surface.
(18) The image processing device according to any one of (1) to (17), further including an eyepoint position detection unit that detects the eyepoint position of the observer of the stereoscopic image,
wherein the image generation unit generates the stereoscopic image on the basis of the eyepoint position.
(19) The image processing device according to (1), wherein the image generation unit
renders the stereoscopic object, generates virtual eyepoint images for both eyes when viewed from the eyepoint position of the observer of the stereoscopic image, and
transforms the virtual eyepoint images to the stereoscopic image to be displayed on the display surface.
(20) An image processing method including: performing scaling transformation on a stereoscopic object according to the angle of a display surface with respect to a horizontal plane of a real space;
generating a stereoscopic image to be displayed on the display surface, by using the stereoscopic object having been subjected to the scaling transformation; and
displaying the stereoscopic image on the display surface.
(21) An image processing device including: a clipping unit that clips a part of a stereoscopic object according to the angle of a display surface with respect to a horizontal plane of a real space and the eyepoint position of an observer of a stereoscopic image displayed on the display surface;
an image generation unit that generates the stereoscopic image by using the partially clipped stereoscopic object; and
a display control unit that displays the stereoscopic image on the display surface.
(22) The image processing device according to (21), wherein the clipping unit clips the stereoscopic object on a plane connecting a fiducial point at a position closer to the display surface than the eyepoint position and one end of the display surface.
(23) The image processing device according to (21), wherein the clipping unit clips the stereoscopic object on a vertical plane or a horizontal plane of a real space or each of the planes, the plane passing through one end of the display surface.
(24) The image processing device according to any one of (21) to (23), further including an eyepoint position detection unit that detects the eyepoint position, wherein the clipping unit clips the stereoscopic object according to the angle and the eyepoint position detected by the eyepoint position detection unit, and the image generation unit generates the stereoscopic image on the basis of the eyepoint position detected by the eyepoint position detection unit.
(25) The image processing device according to any one of (21) to (24), further including a display unit that has the display surface and a structure forming the angle; and
an angle detection unit that detects the angle formed by the structure, wherein
wherein the clipping unit clips the stereoscopic object according to the angle detected by the angle detection unit and the eyepoint position.
(26) The image processing device according to (25), wherein the structure allows the display surface to pivot about one end of the display surface.
(27) The image processing device according to (25), wherein the structure allows the display surface to pivot about a position other than one end of the display surface.
(28) The image processing device according to any one of (25) to (27), further including: an angle setting unit that sets the angle; and an angle control unit that drives the structure such that the angle agrees with an angle set by the angle setting unit.
(29) The image processing device according to (28), wherein the angle setting unit sets the angle according to the stereoscopic object.
(30) The image processing device according to (29), wherein the angle setting unit sets the angle according to the ratio of the depth and the height of the stereoscopic object.
(31) The image processing device according to (30), wherein the angle setting unit sets the angle smaller as the depth is larger relative to the height.
(32) The image processing device according to any one of (28) to (31), wherein the angle control unit drives the structure such that the angle is equal to or larger than a predetermined angle.
(33) The image processing device according to (21), further including a scaling transformation unit that performs scaling transformation on the stereoscopic object according to the angle.
(34) The image processing device according to (33), wherein the scaling transformation unit scales down the stereoscopic object as the angle decreases, whereas the scaling transformation unit scales up the stereoscopic object as the angle increases.
(35) The image processing device according to (34), wherein the scaling transformation unit performs the scaling transformation in a predetermined range of the angle.
(36) The image processing device according to any one of (33) to (35), wherein the scaling transformation unit performs the scaling transformation such that the stereoscopic object is placed in the display surface when viewed from the eyepoint position.
(37) The image processing device according to any one of (33) to (36), wherein the scaling transformation unit performs the scaling transformation to keep the ratio of the height and the width of the stereoscopic object.
(38) The image processing device according to any one of (33) to (36), wherein the scaling transformation unit performs the scaling transformation only in the height direction of the stereoscopic object.
(39) The image processing device according to any one of (21) to (38), wherein the image generation unit
renders the stereoscopic object,
generates virtual eyepoint images for both eyes when viewed from the eyepoint position, and
transforms the virtual eyepoint images to the stereoscopic image to be displayed on the display surface.
(40) An image processing method including: clipping a part of a stereoscopic object according to the angle of a display surface with respect to a horizontal plane of a real space and the eyepoint position of an observer of a stereoscopic image displayed on the display surface; and
generating the stereoscopic image by using the partially clipped stereoscopic object and displaying the stereoscopic image on the display surface.

### REFERENCE SIGNS LIST

100 Spatial reproduction display system
101 Spatial reproduction display device
102 Spatial reproduction controller
111 Eyepoint position detection unit
112 Display unit
113 Angle detection unit
121 Scaling transformation unit
122 Image generation unit
123 Display control unit
131 Observer
131A Eyepoint
141 Display surface
142 Fixed portion
143 Hinge portion
155 Stereoscopic object
181 Stereoscopic object
211 Angle control unit
221 Display-surface-angle setting unit
231 Stereoscopic object
241 Stereoscopic object
321 Clipping unit
331 Stereoscopic object
900 Computer

1. An image processing device comprising: a scaling transformation unit that performs scaling transformation on a stereoscopic object according to an angle of a display surface with respect to a horizontal plane of a real space;
an image generation unit that generates a stereoscopic image to be displayed on the display surface, by using the stereoscopic object having been subjected to the scaling transformation; and
a display control unit that displays the stereoscopic image on the display surface.

2. The image processing device according to claim 1, wherein the scaling transformation unit scales down the stereoscopic object as the angle decreases, whereas the scaling transformation unit scales up the stereoscopic object as the angle increases.

3. The image processing device according to claim 2, wherein the scaling transformation unit performs the scaling transformation in a predetermined range of the angle.

4. The image processing device according to claim 1, wherein the scaling transformation unit performs the scaling transformation such that the stereoscopic object is placed in the display surface when viewed from an eyepoint position of an observer.

5. The image processing device according to claim 1, wherein the scaling transformation unit performs the scaling transformation to keep a ratio of a height and a width of the stereoscopic object.

6. The image processing device according to claim 1, wherein the scaling transformation unit performs the scaling transformation only in a height direction of the stereoscopic object.

7. The image processing device according to claim 1, further comprising a display unit that has the display surface and a structure forming the angle; and
an angle detection unit that detects the angle formed by the structure, wherein
the scaling transformation unit performs the scaling transformation according to the angle detected by the angle detection unit.

8. The image processing device according to claim 7, wherein the structure allows the display surface to pivot about one end of the display surface.

9. The image processing device according to claim 7, wherein the structure allows the display surface to pivot about a position other than one end of the display surface.

10. The image processing device according to claim 7, further comprising: an angle setting unit that sets the angle; and
an angle control unit that drives the structure such that the angle agrees with an angle set by the angle setting unit.

11. The image processing device according to claim 10, wherein the angle setting unit sets the angle according to the stereoscopic object.

12. The image processing device according to claim 11, wherein the angle setting unit sets the angle according to a ratio of a depth and a height of the stereoscopic object.

13. The image processing device according to claim 12, wherein the angle setting unit sets the angle smaller as the depth is larger relative to the height.

14. The image processing device according to claim 10, wherein the angle control unit drives the structure such that the angle is equal to or larger than a predetermined angle.

15. The image processing device according to claim 1, further comprising a clipping unit that clips the stereoscopic object according to the angle and an eyepoint position of an observer of the stereoscopic image.

16. The image processing device according to claim 15, wherein the clipping unit clips the stereoscopic object on a plane connecting a fiducial point at a position closer to the display surface than the eyepoint position and one end of the display surface.

17. The image processing device according to claim 15, wherein the clipping unit clips the stereoscopic object on a vertical plane or a horizontal plane of a real space or each of the planes, the plane passing through one end of the display surface.

18. The image processing device according to claim 1, further comprising an eyepoint position detection unit that detects an eyepoint position of an observer of the stereoscopic image,
wherein the image generation unit generates the stereoscopic image on a basis of the eyepoint position.

19. The image processing device according to claim 1, wherein the image generation unit
renders the stereoscopic object,
generates virtual eyepoint images for both eyes when viewed from an eyepoint position of an observer of the stereoscopic image, and
transforms the virtual eyepoint images to the stereoscopic image to be displayed on the display surface.

20. An image processing method comprising: performing scaling transformation on a stereoscopic object according to an angle of a display surface with respect to a horizontal plane of a real space;
generating a stereoscopic image to be displayed on the display surface, by using the stereoscopic object having been subjected to the scaling transformation; and
displaying the stereoscopic image on the display surface.
